(19) United States
(12) Patent Application Publication
(10) Pub. No.: US 2020/0248854 A1
(43) Pub. Date: Aug. 6, 2020

(54) COUPLING ARRANGEMENT

(71) Applicant: Stedlin Manufacturing Incorporated, Superior, WI (US)

(72) Inventor: Frank Stearns, Superior, WI (US)

(21) Appl. No.: 16/779,009

(22) Filed: Jan. 31, 2020

Related U.S. Application Data
(60) Provisional application No. 62/799,436, filed on Jan. 31, 2019.

(51) Int. Cl. F16L 37/244; F16L 37/23

(52) U.S. Cl. CPC F16L 37/2445; F16L 37/23

(57) ABSTRACT

A coupling arrangement including a first part and a second part that can be selectively coupled and uncoupled. In some examples, the second part includes an internal seal. In some examples, the second part includes a radial flange for momentarily engaging with a safety catch arrangement of the first part when the second part is decoupled from the first part and a fluid pressure within the first internal passageway exceeds a predetermined threshold. In some examples, the second part defines an external groove for accepting ball bearings of the first part, wherein the external groove has a semi-circular shape. In some examples, the first part defines a vent passageway extending from the internal passageway, through a sidewall of a main body part of the first part, and through an interstitial space defined between the sidewall and a sleeve member of the first part. In some examples, the first part includes ball bearings formed from a polymeric material.

### RELATED APPLICATIONS

This application claims priority to U.S. Provisional Patent Application Ser. No. 62/799,436, filed on Jan. 31, 2019, the entirety of which is hereby incorporated by reference.

### BACKGROUND

Coupling arrangements are used in compressed air system to interconnect various system components, such as air compressors, piping, and end use devices, such as hand held tools. In some applications, particularly in high pressure applications, it is difficult to place the components of the coupling arrangement together. Additionally, some prior art coupling arrangements are difficult to decouple safely as the parts can become decoupled and ejected at high rates of speed due to high line pressure in the system.

### SUMMARY

Coupling arrangements for use in fluid-carrying piping assemblies, for example compressed air piping assemblies, are disclosed.

A coupling arrangement can include a first part defining a first internal passageway, a piston disposed within the internal passageway, the piston being movable between an open position in which airflow can pass through the internal passageway and a closed position in which airflow through the internal passageway is blocked, a second part defining a second internal passageway, the second part being configured to be selectively coupled and uncoupled with the first part such that the first and second internal passageways are in fluid communication with each other, wherein when the second part is coupled to the first part, the piston is in the open position and when the second part is uncoupled from the first part, the piston is in the closed position, and an internal seal housed within the second part, wherein the internal seal forms a seal between the second part and an outer surface of the piston when the second part is coupled to the first part.

In some examples, the internal seal is an O-ring.

In some examples, the second part is formed from an aluminum material.

In some examples, the second part includes a radial flange for momentarily engaging with a safety catch arrangement of the first part when the second part is decoupled from the first part and a fluid pressure within the first internal passageway exceeds a predetermined threshold.

In some examples, the second part defines an external groove for accepting ball bearings of the first part, wherein the external groove has a semi-circular shape.

In some examples, the first part defines a vent passageway extending from the internal passageway, through a sidewall of a main body part of the first part, and through an interstitial space defined between the sidewall and a sleeve member of the first part.

A coupling arrangement can include a first part defining a first internal passageway and including a safety catch arrangement, a piston disposed within the internal passageway, the piston being movable between an open position in which airflow can pass through the internal passageway and a closed position in which airflow through the internal passageway is blocked, a second part defining a second internal passageway, the second part being configured to be selectively coupled and uncoupled with the first part such that the first and second internal passageways are in fluid communication with each other, wherein when the second part is coupled to the first part, the piston is in the open position and when the second part is uncoupled from the first part, the piston is in the closed position, wherein the second part includes a radial flange for momentarily engaging with the safety catch arrangement when the second part is decoupled from the first part and a fluid pressure within the first internal passageway exceeds a threshold.

In some examples, the safety catch arrangement includes a lock member and a lock ring receivable by the lock member.

In some examples, the lock ring is a split ring movable between first and second diameters.

In some examples, the lock ring engages with the radial flange of the second part.

In some examples, the lock ring has a first surface that abuts a second surface of the radial flange and wherein the first and second surfaces are disposed at an oblique angle to a longitudinal axis of the coupling arrangement.

In some examples, the internal seal is an O-ring.

In some examples, the second part is formed from an aluminum material.

In some examples, the lock member is movable between a locked position and an unlocked position such that when in the locked position, the lock ring is prevented from expanding to the second diameter such that the second part is locked in position by the lock ring, and such that when in the unlocked position, the lock ring is enabled to expand to the second diameter such that the second part is removable from the first part.

The coupling arrangement of claim 2, wherein the safety catch arrangement further includes a carrier with an internal recess receiving the lock ring, wherein the carrier has an external surface for receiving ball bearings of the first part such that the second part is free of direct contact from the ball bearings when the second part is coupled to the first part.

A coupling arrangement can include a first part defining a first internal passageway, a piston disposed within the internal passageway, the piston being movable between an open position in which airflow can pass through the internal passageway and a closed position in which airflow through the internal passageway is blocked, a second part defining a second internal passageway, the second part being configured to be selectively coupled and uncoupled with the first part such that the first and second internal passageways are in fluid communication with each other, wherein when the second part is coupled to the first part, the piston is in the open position and when the second part is uncoupled from the first part, the piston is in the closed position, and wherein the first part defines a vent passageway extending from the internal passageway, through a sidewall of a main body part of the first part, and through an interstitial space defined between the sidewall and a sleeve member of the first part.

In some examples, the coupling arrangement can further include an internal seal housed within the second part, wherein the internal seal forms a seal between the second part and an outer surface of the piston when the second part is coupled to the first part.

In some examples, the internal seal is an O-ring.

In some examples, the second part is formed from an aluminum material.

In some examples, the second part includes a radial flange for momentarily engaging with a safety catch arrangement of the first part when the second part is decoupled from the first part and a fluid pressure within the first internal passageway exceeds a predetermined threshold.

In some examples, the second part defines an external groove for accepting ball bearings of the first part, wherein the external groove has a semi-circular shape.

A coupling arrangement can include a first part defining a first internal passageway, a piston disposed within the internal passageway, the piston being movable between an open position in which airflow can pass through the internal passageway and a closed position in which airflow through the internal passageway is blocked, a second part defining a second internal passageway, the second part being configured to be selectively coupled and uncoupled with the first part such that the first and second internal passageways are in fluid communication with each other, wherein when the second part is coupled to the first part, the piston is in the open position and when the second part is uncoupled from the first part, the piston is in the closed position, the second part including an external groove, a plurality of ball bearings housed within the first part, the ball bearings being formed from a polymeric material, and a sleeve member securing the plurality of ball bearings within the first part, the sleeve member being movable between an extended positon and a retracted position, wherein when the sleeve member is in the extended position, the plurality of ball bearings are moved into a first position such that the ball bearings can be received in the external groove to lock the second part to the first part, wherein when the sleeve member is in the retracted position, the plurality of ball bearings can be displaced out of the external groove to release the second part from the first part.

In some examples, the plurality of ball bearings are formed from DELRIN.

In some examples, the plurality of ball bearings includes six to ten ball bearings.

In some examples, the external groove has a semi-circular shape.

In some examples, the coupling arrangement can further include an internal seal housed within the second part, wherein the internal seal forms a seal between the second part and an outer surface of the piston when the second part is coupled to the first part.

In some examples, the internal seal is an O-ring.

In some examples, the second part is formed from an aluminum material.

In some examples, the second part includes a radial flange for momentarily engaging with a safety catch arrangement of the first part when the second part is decoupled from the first part and a fluid pressure within the first internal passageway exceeds a predetermined threshold.

In some examples, the first part defines a vent passageway extending from the internal passageway, through a sidewall of a main body part of the first part, and through an interstitial space defined between the sidewall and a sleeve member of the first part.

A compressed air plug configured for selectively coupling and decoupling with a female part of a coupling arrangement can include a sidewall defining an internal passageway and extending between a first end and a second end, a seal member disposed within the internal passageway and between the first and second ends, the seal member being configured to form a seal with a piston of the second part.

In some examples, the seal member is an O-ring.

In some examples, the sidewall is formed from an aluminum material.

In some examples, the sidewall defines an external groove for accepting ball bearings of the female part, wherein the external groove has a semi-circular shape.

In some examples, the first end of the sidewall includes a radial flange configured to engage with a component of the coupling arrangement.

A compressed air plug configured for selectively coupling and decoupling with a female part of a coupling arrangement can include a sidewall defining an internal passageway and extending between a first end and a second end and an external groove defined within the sidewall, the external groove being for accepting ball bearings of the female part, wherein the external groove has a semi-circular shape.

In some examples, the seal member is an O-ring.

In some examples, the sidewall is formed from an aluminum material.

In some examples, the compressed air plug can further include a seal member disposed within the internal passageway and between the first and second ends, the seal member being configured to form a seal with a piston of the second part.

In some examples, the first end of the sidewall includes a radial flange configured to engage with a component of the coupling arrangement.

A variety of additional aspects will be set forth in the description that follows. The aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of a schematic representation of a coupling arrangement with a first connector part and a second connector part in a coupled state having features in accordance with the present disclosure.

FIG. 2 is a perspective view of the coupling arrangement shown in FIG. 1, with the coupling arrangement shown in a decoupled state.

FIG. 3 is a cross-sectional view of the coupling arrangement shown in FIG. 1 in a coupled state.

FIG. 3A is a cross-sectional view of the coupling arrangement shown in FIG. 1 in a decoupled state.

FIG. 4 is an exploded perspective view of a portion of the coupling arrangement shown in FIG. 1.

FIG. 5 is a perspective view of a second connector part of the coupling arrangement shown in FIG. 1.

FIG. 6 is a side view of the second connector part shown in FIG. 5.

FIG. 7 is a first end view of the second connector part shown in FIG. 5.

FIG. 8 is a second end view of the second connector part shown in FIG. 5.

FIG. 9 is a cross-sectional view of the second connector part shown in FIG. 5.

FIG. 10 is a perspective view of a first body of the first connector part of the coupling arrangement shown in FIG. 1.

FIG. 11 is a side view of the first body shown in FIG. 10.

FIG. 12 is a first end view of the first body shown in FIG. 10.

FIG. 13 is a second end view of the first body shown in FIG. 10.

FIG. 14 is a cross-sectional view of the first body shown in FIG. 10.

FIG. 15 is a perspective view of a second body of the first connector part of the coupling arrangement shown in FIG. 1.

FIG. 16 is a side view of the second body shown in FIG. 15.

FIG. 17 is a first end view of the second body shown in FIG. 15.

FIG. 18 is a second end view of the second body shown in FIG. 15.

FIG. 19 is a cross-sectional view of the second body shown in FIG. 15.

FIG. 20 is a perspective view of a sleeve part of the coupling arrangement shown in FIG. 1.

FIG. 21 is a side view of the sleeve part shown in FIG. 20.

FIG. 22 is a first end view of the sleeve part shown in FIG. 20.

FIG. 23 is a second end view of the sleeve part shown in FIG. 20.

FIG. 24 is a cross-sectional view of the sleeve part shown in FIG. 20.

FIG. 25 is a perspective view of a first ring of the first connector part of the coupling arrangement shown in FIG. 1.

FIG. 26 is a cross-sectional view of the first ring shown in FIG. 25.

FIG. 27 is a perspective view of a second ring of the first connector part of the coupling arrangement shown in FIG. 1.

FIG. 28 is a cross-sectional view of the second ring shown in FIG. 27.

FIG. 29 is a perspective view of a piston of the first connector part of the coupling arrangement shown in FIG. 1.

FIG. 30 is a first side view of the piston shown in FIG. 29.

FIG. 31 is a second side view of the piston shown in FIG. 29.

FIG. 32 is a cross-sectional view of the piston shown in FIG. 29.

FIG. 33 is a first end view of the piston shown in FIG. 29.

FIG. 34 is a second end view of the piston shown in FIG. 29.

FIGS. 35 to 38 show the coupling arrangement of FIG. 1 moving from a decoupled state to a coupled state.

FIG. 39 shows the coupling arrangement shown in FIG. 35 in a coupled state.

FIGS. 40 to 43 show the coupling arrangement of FIG. 35 moving from a coupled state to a decoupled state.

FIG. 44 is a perspective view of a schematic representation of a second example of a coupling arrangement with a first connector part and a second connector part in a coupled state having features in accordance with the present disclosure.

FIG. 45 is a perspective view of the coupling arrangement shown in FIG. 44, with the coupling arrangement shown in a decoupled state.

FIG. 46 is a cross-sectional view of the coupling arrangement shown in FIG. 44 in the coupled state.

FIG. 46A is a cross-sectional view of the coupling arrangement shown in FIG. 44, in the decoupled state.

FIG. 47 is a perspective view of a second connector part of the coupling arrangement shown in FIG. 44.

FIG. 48 is an exploded perspective view of the second connector part shown in FIG. 47.

FIG. 49 is a side view of the second connector part shown in FIG. 47.

FIG. 50 is a cross-sectional side view of the second connector part shown in FIG. 47.

FIG. 51 is a cross-sectional view of a schematic representation of a third example of a coupling arrangement with a first connector part and a second connector part in a coupled state having features in accordance with the present disclosure.

FIG. 52 is a cross-sectional view of the coupling arrangement shown in FIG. 51, with the coupling arrangement shown in a decoupled state.

FIG. 53 is a perspective view of a schematic representation of a third example of a coupling arrangement with a first connector part and a second connector part in a coupled state having features in accordance with the present disclosure.

FIG. 54 is a perspective view of the coupling arrangement shown in FIG. 53, with the coupling arrangement shown in a decoupled state.

FIG. 55 is an exploded perspective view of a portion of the coupling arrangement shown in FIG. 53.

FIG. 56 is a cross-sectional view of the coupling arrangement shown in FIG. 53 in the coupled state.

FIG. 57 is a cross-sectional view of the first part of the coupling arrangement shown in FIG. 53, in the decoupled state.

FIG. 58 is a cross-sectional view of a variation of the coupling arrangement shown in FIG. 53.

FIG. 59 is a cross-sectional view of a variation of the coupling arrangement shown in FIG. 53.

FIG. 60 is a perspective view of a schematic representation of a coupling arrangement with a first connector part and a second connector part in a coupled state having features in accordance with the present disclosure.

FIG. 61 is a perspective view of the coupling arrangement shown in FIG. 60, with the coupling arrangement shown in a decoupled state.

FIG. 62 is a cross-sectional view of the coupling arrangement shown in FIG. 60 in a coupled state.

FIG. 63 is a cross-sectional view of the coupling arrangement shown in FIG. 60 in a decoupled state.

FIG. 64 is an exploded perspective view of a portion of the coupling arrangement shown in FIG. 60.

FIG. 65 is a perspective view of a second connector part of the coupling arrangement shown in FIG. 60.

FIG. 66 is a side view of the second connector part shown in FIG. 65

FIG. 67 is a first end view of the second connector part shown in FIG. 65.

FIG. 68 is a second end view of the second connector part shown in FIG. 65.

FIG. 69 is a cross-sectional view of the second connector part shown in FIG. 65.

FIG. 70 is a perspective view of a first body of the first connector part of the coupling arrangement shown in FIG. 60.

FIG. 71 is a side view of the first body shown in FIG. 70.

FIG. 72 is a first end view of the first body shown in FIG. 70.

FIG. 73 is a second end view of the first body shown in FIG. 70.

FIG. 74 is a cross-sectional view of the first body shown in FIG. 70.

FIG. 75 is a perspective view of a second body of the first connector part of the coupling arrangement shown in FIG. 60.

FIG. 76 is a side view of the second body shown in FIG. 75.

FIG. 77 is a first end view of the second body shown in FIG. 75

FIG. 78 is a second end view of the second body shown in FIG. 75.

FIG. 79 is a cross-sectional view of the second body shown in FIG. 75.

FIG. 80 is a perspective view of a sleeve part of the coupling arrangement shown in FIG. 60.

FIG. 81 is a side view of the sleeve part shown in FIG. 80.

FIG. 82 is a first end view of the sleeve part shown in FIG. 80.

FIG. 83 is a second end view of the sleeve part shown in FIG. 80.

FIG. 84 is a cross-sectional view of the sleeve part shown in FIG. 80.

FIG. 85 is a perspective view of a first ring of the first connector part of the coupling arrangement shown in FIG. 60.

FIG. 86 is a cross-sectional view of the first ring shown in FIG. 85.

FIG. 87 is a perspective view of a second ring of the first connector part of the coupling arrangement shown in FIG. 60.

FIG. 88 is a cross-sectional view of the second ring shown in FIG. 87.

FIG. 89 is a perspective view of the first ring holder of the coupling arrangement shown in FIG. 60.

FIG. 90 is a view of the first end of the first ring holder of FIG. 89.

FIG. 91 is a side view of the first ring holder of FIG. 89.

FIG. 92 is a cross-sectional view of the first ring holder of FIG. 89.

FIG. 93 is a perspective view of a piston of the first connector part of the coupling arrangement shown in FIG. 60.

FIG. 94 is a first side view of the piston shown in FIG. 93.

FIG. 95 is a second side view of the piston shown in FIG. 93.

FIG. 96 is a cross-sectional view of the piston shown in FIG. 93.

FIG. 97 is a first end view of the piston shown in FIG. 93.

FIG. 98 is a second end view of the piston shown in FIG. 93.

FIG. 99 is a cross-sectional view of the coupling arrangement of FIG. 60 in a partially inserted state.

FIG. 100 is a cross-sectional view of the coupling arrangement of FIG. 60 in a safe vent state.

FIG. 101 is a top view of a schematic representation of a coupling arrangement with a first connector part and a second connector part in a coupled state having features in accordance with the present disclosure.

FIG. 102 is a partial cross-sectional view of the coupling arrangement shown in FIG. 101.

FIG. 103 is a side view of a lock ring of the coupling arrangement shown in FIG. 101.

FIG. 104 is an end view of the lock ring shown in FIG. 103.

FIG. 105 is a side view of a carrier of the coupling arrangement shown in FIG. 101.

FIG. 106 is an end view of the carrier shown in FIG. 105.

FIG. 107 is a side view of a lock member of the coupling arrangement shown in FIG. 101.

FIG. 108 is an end view of the lock member shown in FIG. 107.

### DETAILED DESCRIPTION

Various examples will be described in detail with reference to the drawings, wherein like reference numerals represent like parts and assemblies throughout the several views. Reference to various examples does not limit the scope of the claims attached hereto. Additionally, any examples set forth in this specification are not intended to be limiting and merely set forth some of the many possible examples for the appended claims. Referring to the drawings wherein like reference numbers correspond to like or similar components throughout the several figures.

### Coupling Arrangement 100

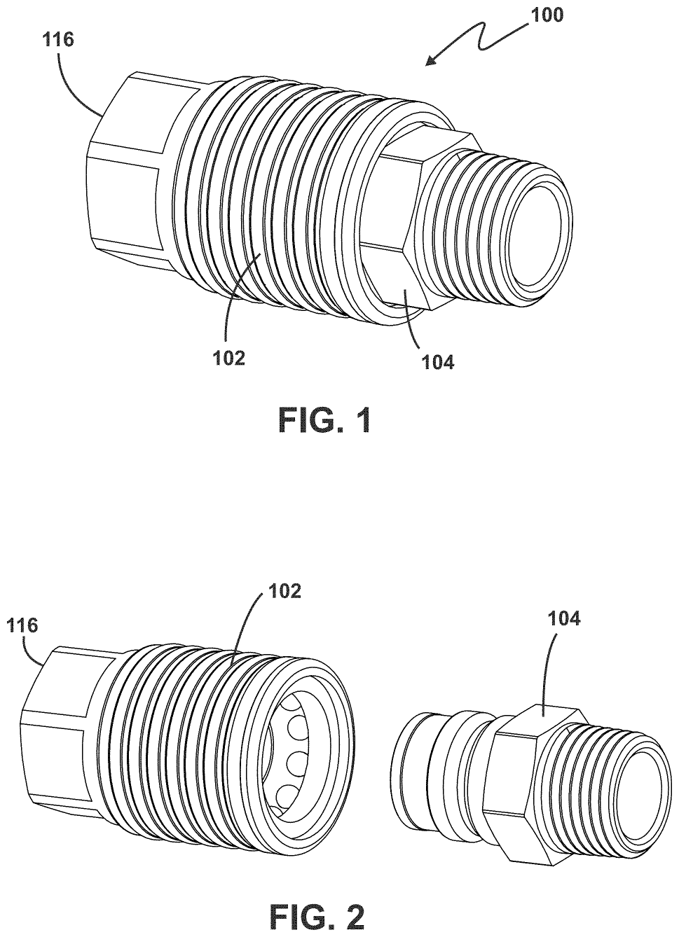

Referring to FIGS. 1 to 3A, a coupling arrangement 100, is presented. Although coupling arrangement 100 can be configured for other types of fluids (e.g. liquids), coupling arrangement 100 is shown as being configured for use with a gas, such as compressed air. As shown, the coupling arrangement 100 is configured as a quick-connect coupler with a first part 102 and a second part 104 received by the first part 102. In one aspect, the first part 102 can be characterized as a female part of the coupling arrangement 100 and the second part 104 can be characterized as a male part of the coupling arrangement 100. The coupling arrangement 100 is configured such that the second part 104 will not disconnect from the first part 102 until a sufficient amount of pressure within the coupling arrangement 100 has been bled out of the coupling arrangement 100. This feature increases safety in ensuring that the second part 104 is not ejected rapidly out of the first part 102 in a way that increases risk of harm to an operator. The coupling arrangement 100 is also configured such that the insertion force required to insert the second part 104 into the first part 102 is relatively low, in comparison to prior art coupling arrangements. This feature is particularly advantageous when the coupling arrangement 100 is utilized in a high pressure environment (e.g. line pressures around 200 psi) where an operator is generally required to apply a significant amount of force to insert a plug into a coupler.

In one aspect, the first part 102 is an assembly including a main body 110 formed by a first body part 112 to which a second body part 114 is connected. In the example shown, the first body part 112 and the second body part 114 have sidewalls 112a, 114a with an axis of symmetry about a longitudinal axis X of the first part 102 and are interconnected by a threaded connection. To facilitate this connection, the first body part 112 is provided with internal threads 112b while the second body part 114 is provided with mating external threads 114b. The reverse arrangement is also possible with the first body part 112 including external threads and the second body part 114 including internal threads. Other connection types are also possible. Also, although more complex to produce, the first part 102 could be unitarily formed as a single body having the features of the first and second body parts 112, 114.

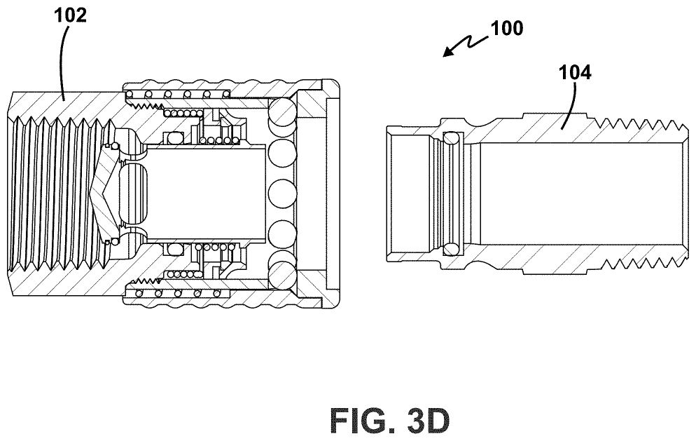

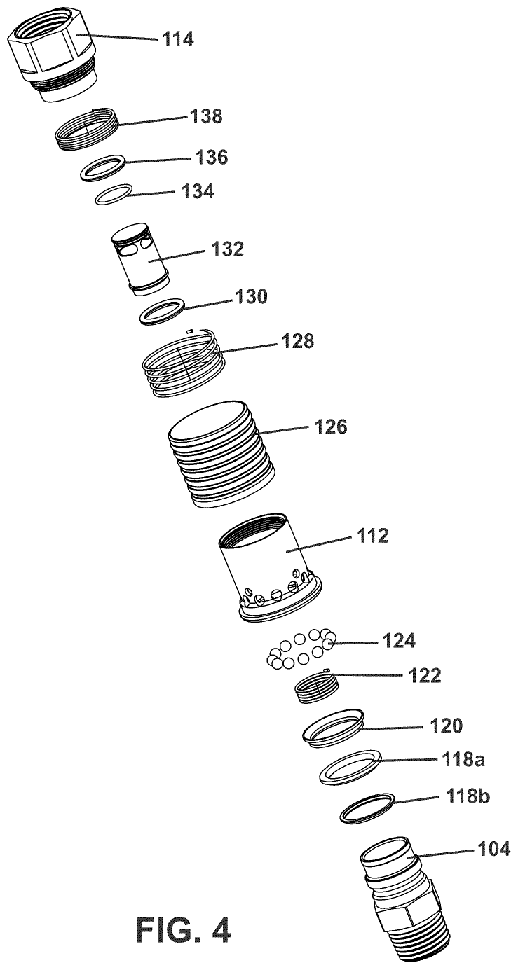

With reference to FIG. 4, an exploded view of the coupling arrangement 100 is presented such that the individual components of the coupling arrangement 100 can be more easily viewed. However, the orbital coupling arrangement 116 of the coupling arrangement 100 is not shown. In order from the second part 104 towards the second body part 114, the coupling arrangement 100 is shown as including, a first ring 118, a second ring 120, a first spring member 122, a plurality of ball bearings 124, the first body part 112, a sleeve member 126, a second spring member 128, a first seal member 130, a piston 132, a second seal member 134, a third seal member 136, a third spring member 138, and the second body part 114. As shown, the first, second, and third spring members 122, 128, 138 are helical or coiled springs that can be formed from a metal material, such as spring steel. The first, second, and third seal members 130, 134, and 136 are shown as being configured as O-rings and can be formed from a polymeric material, such as a rubber material. The remaining aforementioned components and their functions will be described in the following paragraphs.

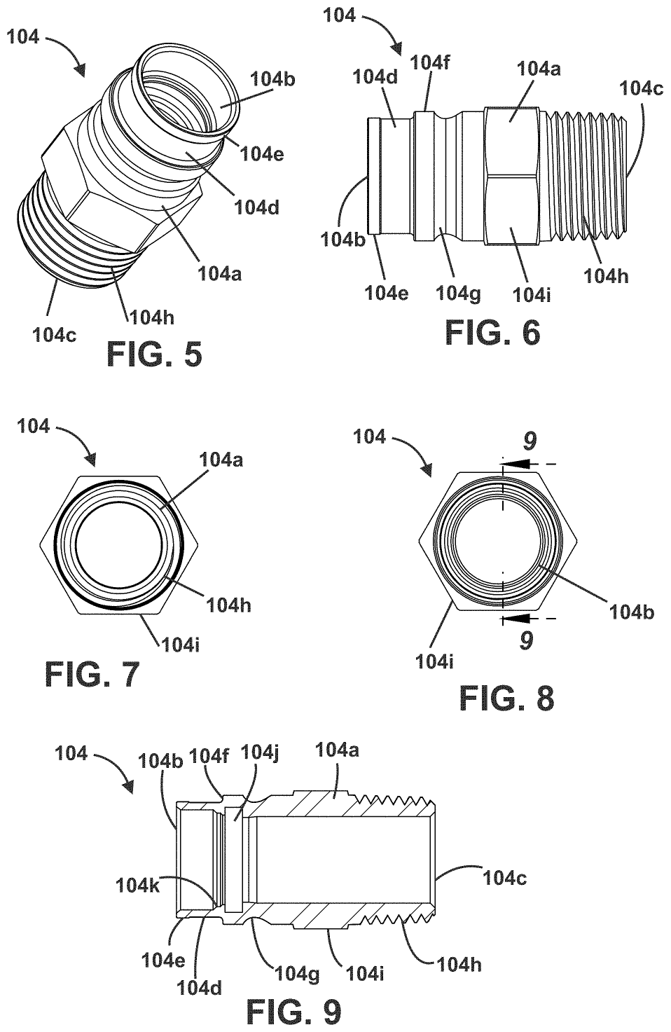

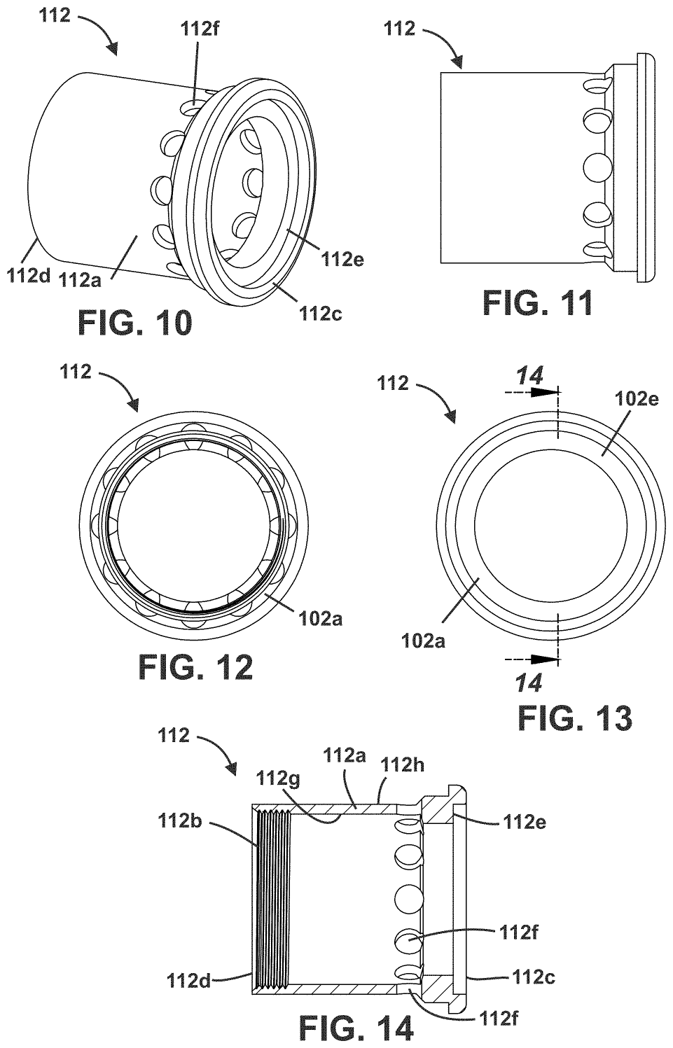

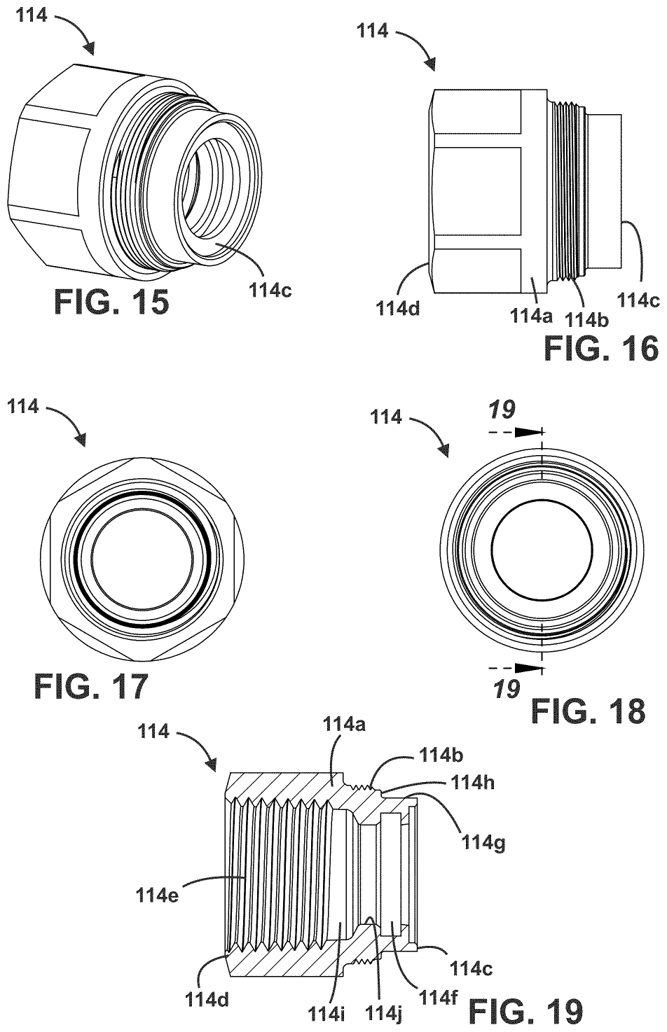

With reference to FIGS. 5 to 9, the second part 104 is shown in isolation such that the details of the second part 104 can be more easily viewed. As shown, the second part 104 includes a sidewall 104a having an axis of symmetry about the longitudinal axis X. The sidewall 104a extends between a first end 104b and a second end 104c. The first end 104b includes an interface for interconnecting with the first part 102 with the interface defining an outer collar surface 104d and a radial flange or shoulder portion 104e. The interface can also be described as including a ramped surface 104f and a bearing recess 104g for respectively guiding and retaining the ball bearings 124 when the first part 102 is fully inserted into the second part 104. In one aspect, the bearing recess 104g has a circular concave shape matching the outer surface of the ball bearings 124. In one aspect, this complementary shape between the recess 104g and the ball bearings 124 creates a smooth interacting surface that enables the ball bearings 124 to provide a low-friction interface between the second part 104 and the first part 102 which in turns enables the first and second parts 102, 104 to easily rotate with respect to each other. This configuration allows for an operator to much more easily handle and articulate a tool connected to the coupling arrangement 100 during use. The second end 104c is shown as including an interface for interconnecting with an air hose or tool. In the example shown a threaded connection 104h with external threads, such as a Tru-Flate 21-143 1/4 NPT male fitting. However, other types of arrangements may be used, such as female threads or a barbed fitting for connecting with an air hose, such as a 3/8 ID hose barb type fitting manufactured by Plews and Edelman of Dixon, Illinois. The sidewall 104a can be provided with a hex-shaped tool interface 104i such that a tool can be used to rotate (or hold in a fixed position) the second part 104 to connect the second part 104 to a tool or other component via threads 104h. The internal side of the sidewall 104a is also shown as defining a seal cavity or channel 104j for receiving and retaining the seal member 130. The seal member 130 operates to ensure an air-tight seal between the second part 104 and an outer surface of the piston, when the second part 104 is inserted into the first part 102. The second part 104 is also shown as including an interior surface 104k for engaging with the piston 132.

With reference to FIGS. 10-14, the first body part 112 is shown in isolation such that the details of the first body part 112 can be more easily viewed. As shown, the first body part sidewall 112a extends between a first end 112c and a second end 112d with the first end 112c defining an end face 112e and the second end 112d defining the aforementioned threaded connection 112b. In one aspect, the end face 112e acts as a stop against the end of the tool interface 104i of the second part 104 to ensure that the second part 104 is not inserted too far into the first part 102. Although the end of the tool interface 104i provides a stop surface, the first part 102 could be configured such that another surface independent of the tool interface 104i acts as a stop surface. For example, a separate radial flange could be provided at the desired axial location.

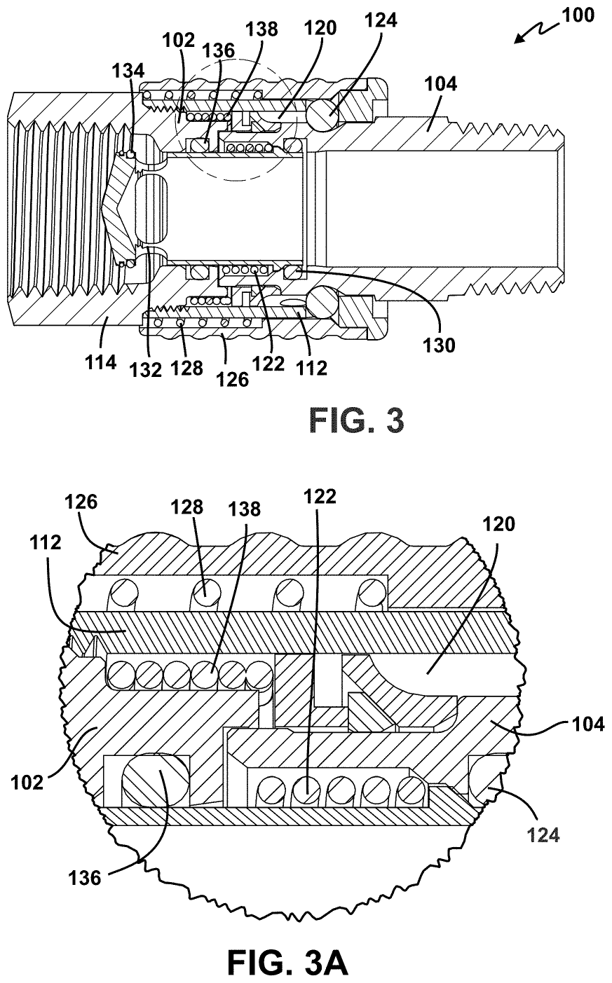

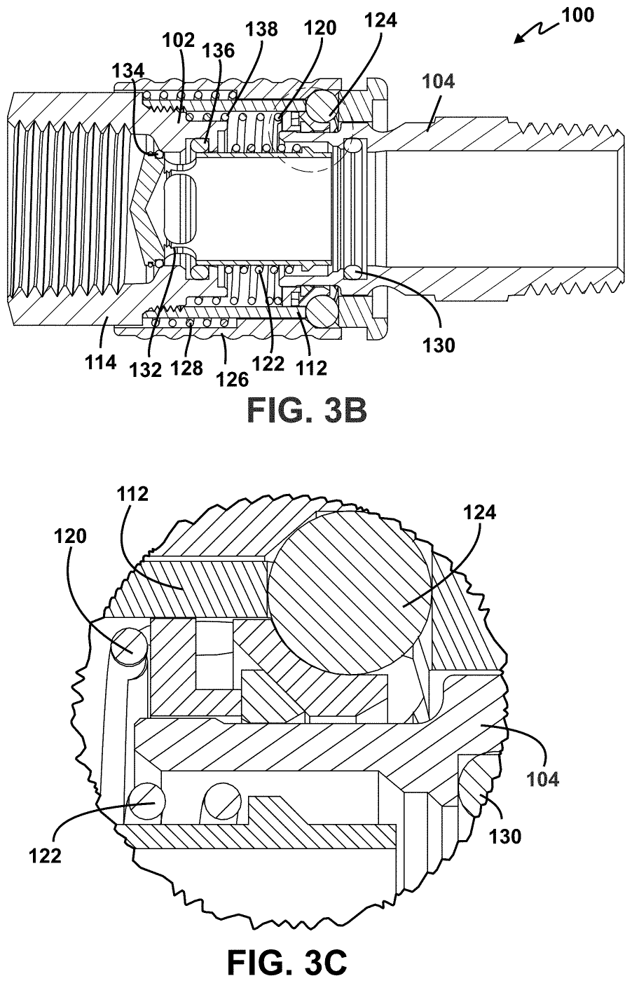

In one aspect, the sidewall 112a further includes a plurality of apertures 112f through which the ball bearings 124 can travel between a first position and a second position, wherein the first position is radially inward relative to the second position. With such an arrangement, the ball bearings 124 cannot pass fully through the apertures 112f In the first position, the ball bearings 124 are as close to the longitudinal axis X as they can be moved such that when the second part 104 is inserted into the first part 102, the ball bearings 124 are engaged within the bearing recess 104g of the second part 104. As can be seen at FIG. 3, the sleeve part 126 acts against an outer surface of the ball bearings 124 to hold the bearings 124 in this position such that the second part 104 is locked to the first part 102. When the sleeve part 126 is moved axially away from the second part 104, the ball bearings 124 can move radially outwardly within the apertures 112f towards the second position such that the ball bearings 124 can slide out of the bearing recess 104g with an axial pulling force applied to the second part 104 in the direction towards the second end 104c. In the example shown, ten apertures 112f and ball bearings 124 are shown as being provided. However, more or fewer apertures 112f and ball bearings 124 could be provided. In the example shown, the ball bearings 124 have a diameter of about one eighth of an inch and are formed from a polymeric material. In some examples, the ball bearings 124 are formed from an acetal thermoplastic (i.e. PolyOxyMethylene or POM) such as copolymer acetal or homopolymer acetal. In some examples, the ball bearings are formed from DELRIN manufactured by DuPont. Other materials are possible, such as metal, although at a higher cost and with reduced functionality in some cases.

In one aspect, the sidewall 112a includes another set of apertures 112g. The apertures 112g are for venting air during disconnection of the second part 104 from the first part 102. The incorporation of the apertures 112g into the sidewall 112a enables for a venting pathway V to be created from the interior side of the sidewall 112a, through the sidewall 112a, and through the interstitial space defined between the exterior of the sidewall 112a and the sleeve member 126. Thus, when the second part 104 is disconnected from the first part 102, the volume of compressed air within the coupling arrangement 100 is directed through the venting pathway V instead of escaping around the second part 104 where it would otherwise be directed towards the operator performing the disconnecting action. As the venting pathway V exit (i.e. pathway defined between sleeve member 126 and sidewall 112a) is directed oppositely from the removal direction of the second part 104, the vented air does not exert an additional force onto the second part 104 during the disconnection action. Thus, the disclosed configuration significantly reduces the ejection pressure exerted on the second part 104 during disconnection. In some prior art arrangements, where the air is vented in the same direction as the removal direction of the plug, the ejection pressure is high enough to cause rapid ejection of the plug to dangerously become a projectile.

With reference to FIGS. 15 to 18, the second body part 114 is shown in isolation such that the details of the second body part 114 can be more easily viewed. As shown, the second body part sidewall 114a extends between a first end 114c and a second end 114d with the threaded connection 114b that interfaces with threaded connection 112c being proximate the first end 114c. The second end 114d is configured with a threaded connection 114e and other features to accept an orbital coupling arrangement 116. An example orbital coupling arrangement 116 suitable for connection to the second body part 114 is shown and described in U.S. patent application Ser. No. 15/958,670, filed on Apr. 20, 2018 and entitled ORBITAL COUPLING ARRANGEMENT, the entirety of which is incorporated by reference herein. The second end 114d can be provided with other types of arrangements for alternative connection types. For example, the second end 114d could be provided with external threads or a barbed fitting for connecting with an air hose. The second body part sidewall 114a is also shown as being provided with an internal seal cavity or channel 114f for retaining seal member 136 such that an air-tight seal can be formed between the second body part 114 and the piston 132. The second body part sidewall 114a is also shown as being provided with an outer collar surface 114g and an adjacent stop surface 114h about and against which spring 138 is disposed, which allows the spring 138 to act against the rings 120 and 118 such that the rings are forced against ramped surface 104f of the second part 104 when the second part 104 is fully installed into the first part 102. When the second part 104 is removed, spring 138 acts between the stop surface 114h and the ring 120 to drive the rings 120 and 118 against the ball bearings 124. The second body part 114 is also shown as being provided with an internal groove or recess 114i for accepting the seal member 136 which provides a seal between the second body part 114 and the piston 132. Where the second body part 114 is configured with a male or female threaded connection (e.g. see connection types shown at FIGS. 58 and 59) instead of being configured as part of an orbital coupling arrangement 116, the presence of the groove 114i may not be provided.

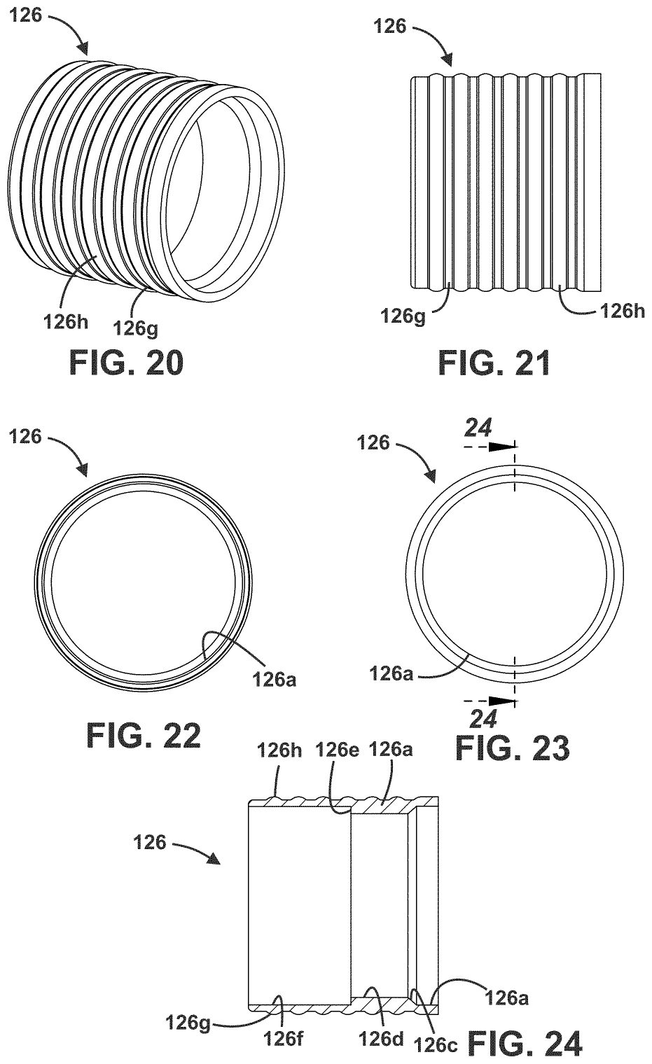

With reference to FIGS. 20 to 24, the sleeve member 126 is shown in isolation such that the details of the sleeve member 126 can be more easily viewed. As shown, the sleeve member 126 includes a sidewall 126a defining inner surfaces 126b, 126c, 126d, 126e, and 126f. The sidewall 126a also defines an outer surface 126g with circumferential ridges 126h to enable an operator to slide the sleeve member 126 with respect to the first body part 112. In one aspect, the ball bearings 124 rest against the inner surface 126b when the sleeve is retracted into an open position such that the ball bearings 124 can move radially outwardly and release the second part 104. As the sleeve is moved towards the closed positon by the force of the spring 128 acting against surface 126e, a ramped inner surface 126c forces the ball bearings 124 further into the apertures 112f of the first body part 112. As the sleeve moves fully into the closed positon by the force of spring 128, the ball bearings 124 are secured against the inner surface 126d and are fully engaged with the recess 104g of the second part 104. In one aspect, the spring 128 resides in the interstitial space between the inner surface 126f of the sleeve member 126 and the outer surface of the first body part 112.

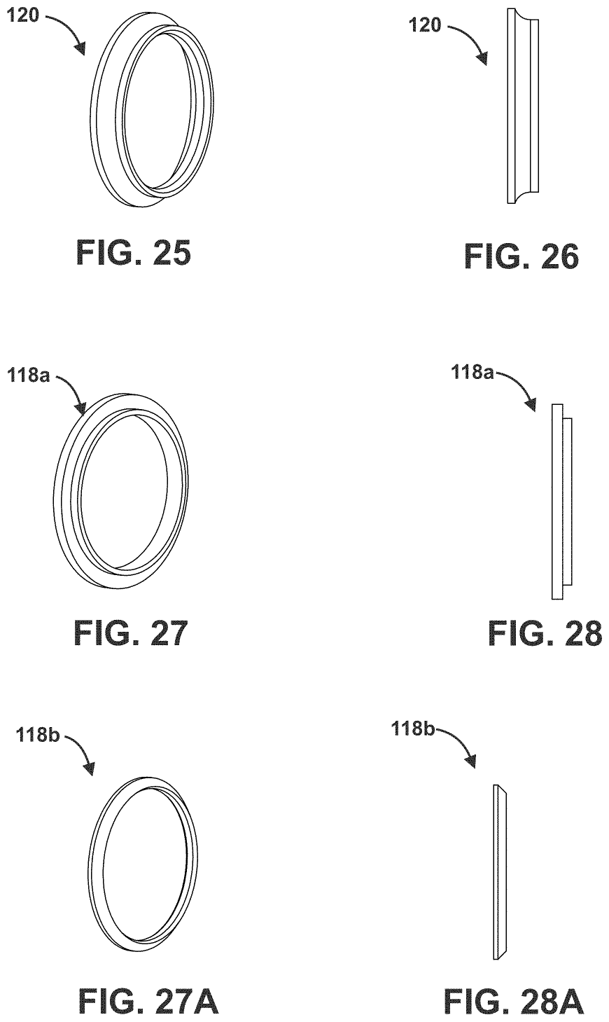

With reference to FIGS. 25 to 27, the ring members 118 and 120 are shown in further detail. In one aspect, the ring 118 includes a sidewall 118a with inner surfaces 118b, 118c, 118d and an outer surface 118e. In one aspect, the ring 120 includes a sidewall 120a with an inner surface 120b and outer surfaces 120c and 120d. The ring 120 is shown as being configured as a split ring 120 having a gap 120e. Once installed, the rings 118, 120 reside within the first body part 112 and are axially displaceable within the first body part 112, as is described further below.

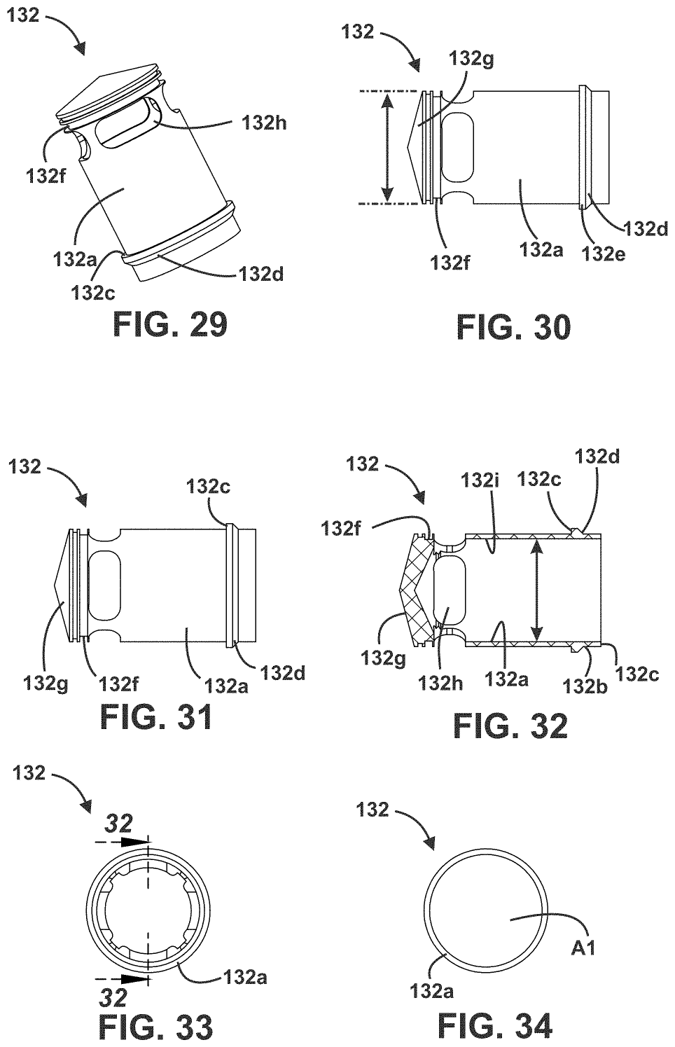

With reference to FIGS. 29 to 34, the piston 132 is shown in isolation such that the details of the piston 132 can be more easily viewed. As shown, the piston 132 includes a sidewall 132a with an outer surface 132b and an inner surface 132i extending between a first end 132c and a second end 132g. The second end 132g is configured with a conically-shaped head, however, other shapes are possible. The piston 132 is shown as further including a ramped surface 132d and a catch surface 132e. In operation, the ramped surface 132d engages with the interior surface 104k of the second part 104 such that the piston 132 is moved into an open position when the second part 104 is fully inserted into the first part 102. The catch surface 132e engages with the spring 122 which biases the piston 132 into a closed position. The piston 132 is further shown as including a groove 132f for accepting a seal member 134 and apertures 132h for allowing air to pass through the piston 132 and into the second body part 114. While two apertures 132h are shown, more or fewer may be provided. In the open position, the piston 132 is moved such that the seal 134 extends beyond an inner surface 114j of the second body part 114 and into an internal cavity 114k of the second body part 114. Consequently, the apertures 132h are exposed to the internal cavity 114k such that air passing from the internal cavity 114k can pass into the interior of the piston 132 via the apertures 132h, and ultimately through the second part 104. When the second part 104 is removed from the first part 102, the spring 122 biases the piston 132 into the closed position such that the seal 134 engages with the inner surface 114j of the second body part 114, thereby sealing the internal cavity 114k from the interior of the piston 132 such that airflow can no longer flow through the first part 102.

In one aspect, the second end 132g has a first cross-sectional diameter D1 and area A1. In order for the piston 132 to move from the closed position to the open position, the second end 132g must overcome the force exerted by the compressed air within the second body part 114. As such the force required to displace the piston 132 into the open position is a function of the first cross-sectional area and the compressed air pressure. This force can also be characterized as the insertion force for the second part 104 to be inserted into the first part 102 since as the piston 132 is displaced into the open position by the interaction between the ramped surface 132d of the piston 132 and the interior surface 104k of the second part 104, as explained previously. In the example shown, the first diameter D1 is about 8 mm resulting in a first cross-sectional area A1 of about 50 square mm. Thus, where the system pressure is about 200 psi, the required insertion force for the second part 104 acting on the piston 132 is about 15 pounds. This insertion force is significantly lower than for industry-standard coupling assemblies which have much larger pistons (e.g. 7/16″ diameter piston head diameters) and can require an insertion force of 50 pounds or more for system pressures of around 200 psi. The disclosed configuration is particularly advantageous as the piston 132 has an internal passageway diameter D2 that is about 7 mm and resulting area A2 which is the same size or larger than industry-standard pistons. Thus, the significantly reduced insertion force of the disclosed configuration is not achieved at the expense of compressed air flow rates and pressures through the coupling assembly 100.

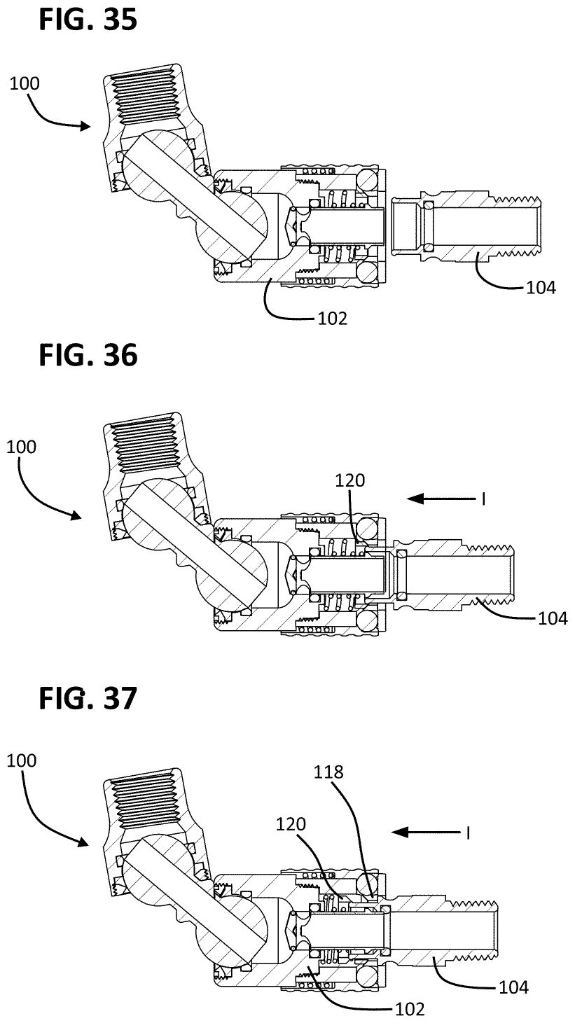

With reference to FIGS. 35 to 43, the coupling and decoupling operations of the coupling arrangement 100 are shown at various stages of interconnection. FIGS. 35 to 38 show the insertion action of the second part 104 into the first part 102, FIG. 39 shows the fully inserted and locked position of the first and second parts 102, 104, and FIGS. 40 to 43 show the disconnection action of the second part 104 from the first part 102.

At FIG. 35, the second part 104 is axially aligned with the first part 102 such that the second part 104 can be inserted into the first part 102 in the insertion direction I.

At FIG. 36, the second part 104 is displaced in the insertion direction I into the first part 102 where contact is initially made between radial flange or shoulder portion 104e of the second part 104 and the surface 120c of the ring 120.

At FIG. 37, the second part 104 is further inserted into the first part 102 while carrying the ring 118 in the same direction and with the surface 104f engaging with surface 118d of the ring 118. As the ring 120 moves in the insertion direction, the spring 138 is compressed against the ring 120. In this position, the seal member 130 of the second part 104 makes sealing contact with the outside surface 132b of the piston 132 such that compressed air flowing through the piston 132 is sealed as it passes into the second part 104 and cannot otherwise escape. Notably, sealing contact is made between the seal member 130 and the piston 132 prior to the piston 132 being moved into the open position.

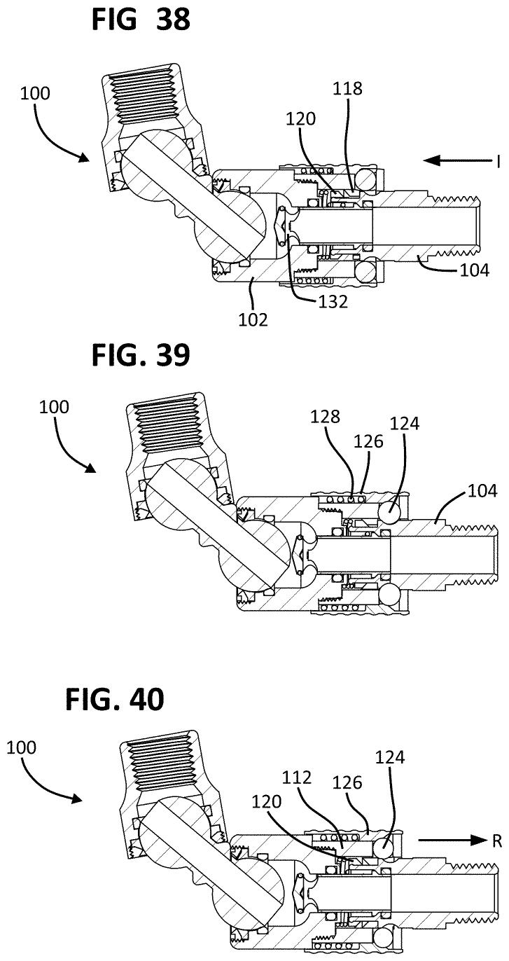

At FIG. 38, the second part 104 and both rings 118, 120 are further carried in the insertion direction with the ring 120 reaching its maximum insertion direction defined by the full compression against spring 138. FIG. 38 also shows the initial contact between surface 104f of the second part 104 and the surface 132d of the piston 132 whereby any further insertion of the second part 104 in the insertion direction I will cause the piston 132 to move from the closed positon towards the open position. As related earlier, the insertion force created by the compressed air on the other side of the piston 132 must be overcome in order for further displacement in the insertion direction I to occur.

At FIG. 39, the second part 104 and ring 118 are further carried in the insertion direction until the surface 118b of ring 118 abuts surface 120c of ring 120. In this positon, the piston 132 has been moved into the open position, the radial flange or shoulder portion 104e of the second part 104 has carried past the ring 120 in the insertion direction, the ring 118 has been carried beyond the ball bearings 124, and the ball bearings 124 have moved into the groove 104g of the second part 104. The ball bearings 124 are moved into this position via contact with surface 126c of the sleeve member 126 which is biased towards the ball bearings 124 via the spring 128. The spring 128 continues to acts against the sleeve member 126 such that the surface 126d of the sleeve member 126 is adjacent to the ball bearings 124 to lock the ball bearings 124 into the groove 104g of the second part 104, thereby locking the second part 104 into the first part 102.

At FIG. 40, the sleeve member 126 has been moved away from the ball bearings 124 (i.e. in the insertion direction I), thereby allowing the ball bearings 124 to move back further into the apertures 112f of the first body part 112. FIG. 40 also shows the second part 104 being partially moved in the removal direction such that the groove 104g of the second part 104 has driven the ball bearings 124 into apertures 112f. As the piston 132 is still in the open position, the compressed air within the coupling assembly 100 is acting on the piston 132 and the second part 104 in the removal direction R, thereby urging the second part 104 to eject from the first part 102. As the second part 104 moves in the removal direction, the radial flange or shoulder 104e catches on the ring 120 and carries the ring 120 with the second part 104. The compressed air also acts on the ring 120 to drive the ring 120 in the removal direction.

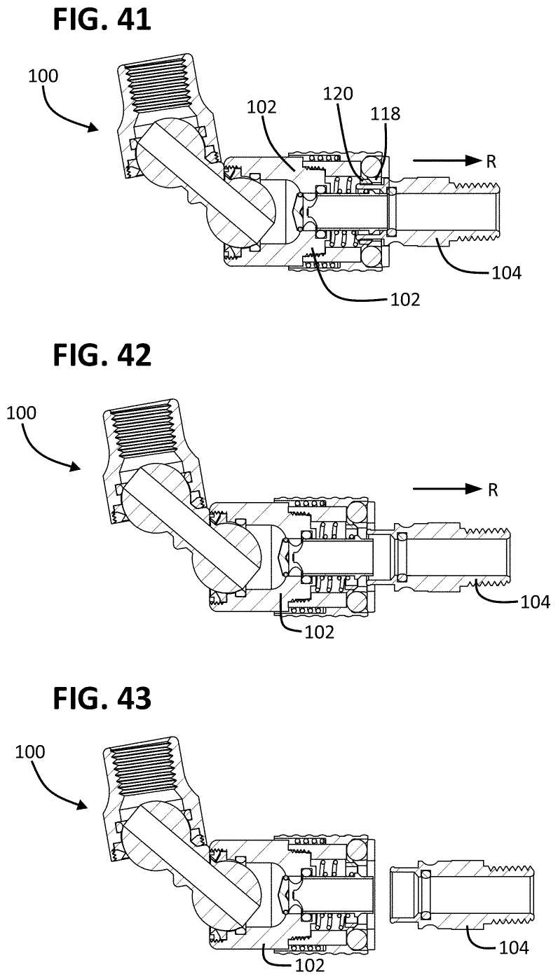

At FIG. 41, the rings 118 and 120 have moved to their furthest position in the removal direction R with the radial flange or shoulder 104e still engaged with the ring 120. Due to the compressed air pressure, the ring 120 is driven into the ring 118 such that the surface 120c of ring 120 abuts surface 118b of ring 118. As the ring 120 is prevented from further movement in the removal direction by the first body part 112, the compressed air force and interaction between the obliquely angled surfaces 118b, 120c causes the ring 118 to collapse into a smaller diameter, which is enabled by the gap 120e. Once collapsed, as is shown in FIG. 41, the ring 120 locks against the radial flange or shoulder 104e and thereby prevents the second part 104 from being ejected from the first part 102 in the removal direction R. Thus, the radial flange or shoulder 104e and rings 118, 120 operate together as a safety feature to prevent the second part 104 at a high rate of speed. At this position, the piston 132 has moved to the closed position such that compressed air from the system is isolated from the interior of the first body part 112 where the rings 118, 120 are located. Once the compressed air within the first body part 112 has vented sufficiently through the venting pathway V, the force on the ring 120 dissipates and the ring 120 returns to a relaxed state, thereby unlocking the ring 120 from the radial flange or shoulder 104e.

At FIG. 42, the ring 120 has returned to its relaxed state and the second part 104 has moved further in the removal direction with the radial flange or shoulder 104e having moved past the ring 120. From this position, the second part 104 is now free to be fully removed from the first part 102. FIG. 43, the second part 104 has been fully removed and is in the disconnected position.

In one aspect, an advantage of the configuration presented in the disclosure is that the ball bearings 124 can be made of a softer material than steel, for example a polymeric material such as Delrin. The ball bearings 124 can also be made with a smaller diameter. Fewer ball bearings 124 can also be provided. This is at least partly due to the groove 104g having a complementary shape (i.e. a semi-circular shape) with the ball bearings 124 and at least partially due to the lower forces exerted on the ball bearings 124 as a result of the piston 132 having a relatively smaller first cross-sectional area A1. One advantage of utilizing plastic ball bearings is reduced cost. Another advantage of plastic ball bearings is that they greatly reduce friction such that connected tool can swivel relatively freely with respect to the plug and hose. Yet another advantage of plastic ball bearings is that they also function as shock absorbers which therefore enables the second part 104 to be constructed of a softer material than steel, such as aluminum, thereby saving weight in the overall assembly. Some prior art ball bearing locking couplers require hardened steel plugs (i.e. second parts) when used with certain air tools such as air hammers and impact wrenches. The purpose of the curved locking surface 104g of the second part 104 is to reduce the stress concentration when used with high impact air tools. This reduced stress design allows for the use of non-metallic ball bearings 124 and second parts 104 from material such as polyurethane. Thus technique requires that the couplers and plugs be manufactured to close tolerances.

### Coupling Arrangement 200

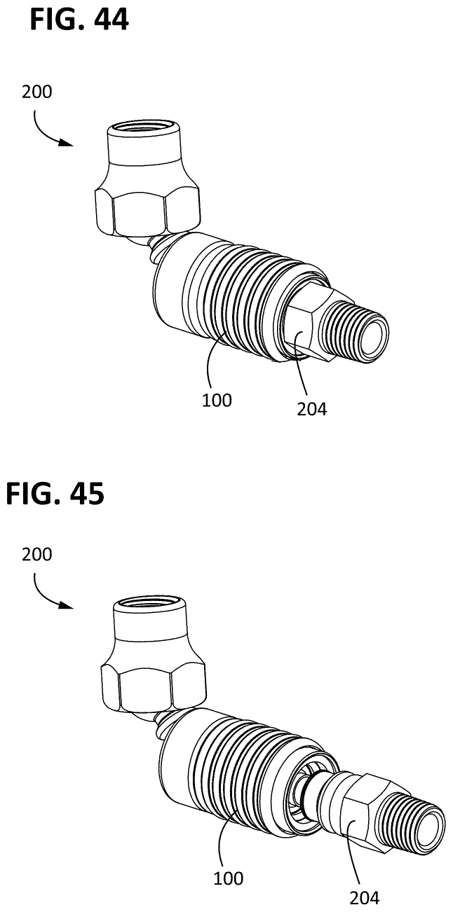

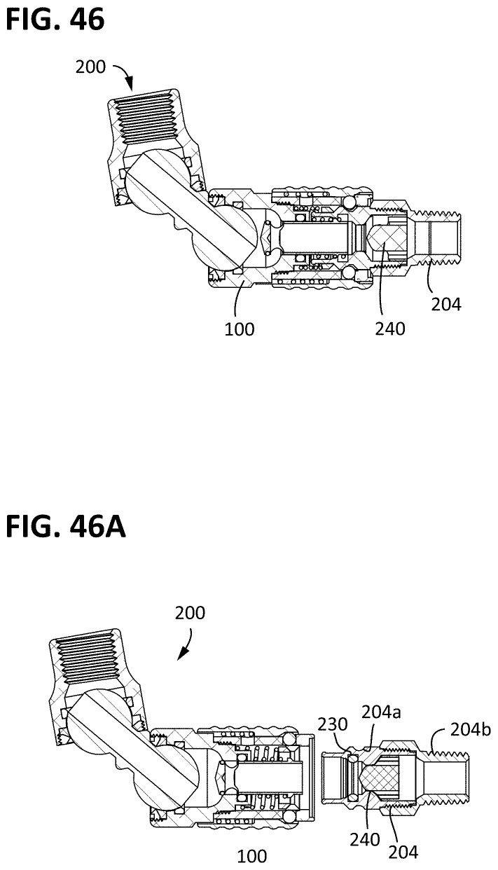

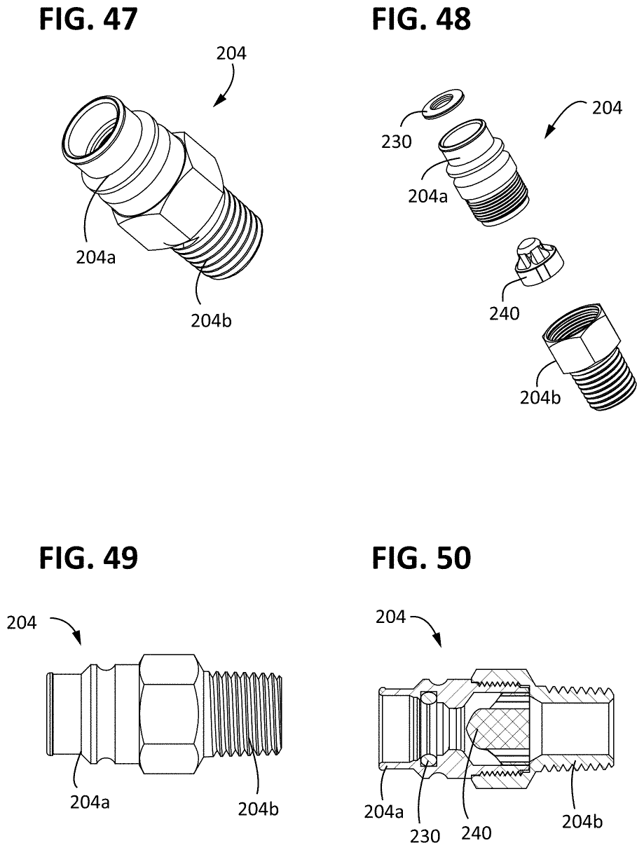

Referring to FIGS. 44 to 50, a variation of the coupling assembly 100 is presented in which the first part 100 is coupled with a modified second part 204 is shown. In the example shown, the coupling assembly 200 includes a second part 204 that is additionally provided with a valve 240. In one aspect, the valve 240 is configured with a sidewall defining an interior passageway extending along a longitudinal axis between a first open end and a second open end, and is movable within the second part 204. The valve 240 is movable between a normal air flow position and a sound reduction position, wherein in the normal airflow position, the valve 240 has less than a 10 psi pressure drop at an airflow rate of 20 to 50 scfm through the interior passageway. In the sound reduction position, the valve 240 reduces a coupler disconnect sound level by at least 20 dBA in comparison to a disconnect sound level when the connector body is used without the valve 240 installed within the interior passageway. The design and operation of the valve 240 is disclosed in U.S. patent application Ser. No. 15/942641 filed on Apr. 2, 2018 and entitled High Pressure Coupler, the entirety of which is incorporated by reference herein. In one aspect, the second part 204 is constructed with a two part housing with a first part 204a threaded onto a second part 204b to enable installation of the valve 240.

### Coupling Arrangement 300

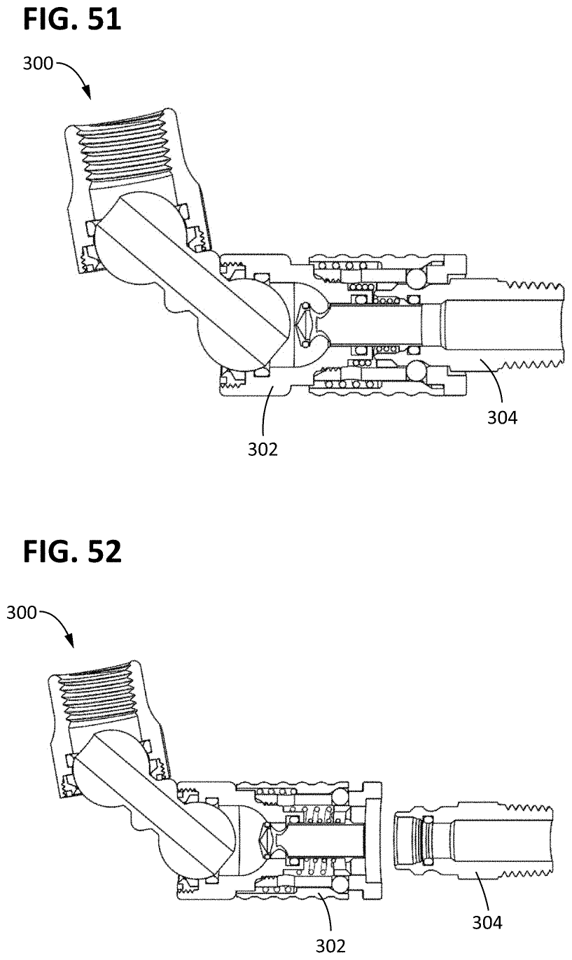

Referring to FIGS. 51 and 52, a variation of the coupling assembly 100 is presented in which a coupling assembly 300 having a first part 302 and a second part 304 is shown. In one aspect, the first part 302 is provided without the ring 120 and the second part 304 is provided without a radial flange. In such a configuration, the safety feature of preventing uncontrolled ejection of the second part 204 during the decoupling process is removed. The coupling assembly 300 is also configured with smaller dimensions such that the piston 132 has an even further reduced cross-sectional first area A1.

### Coupling Arrangement 400

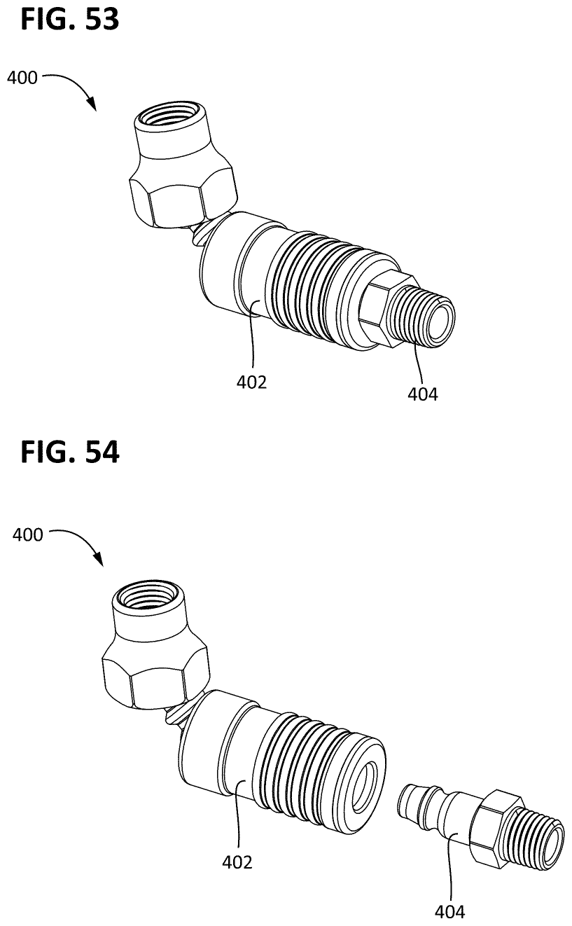

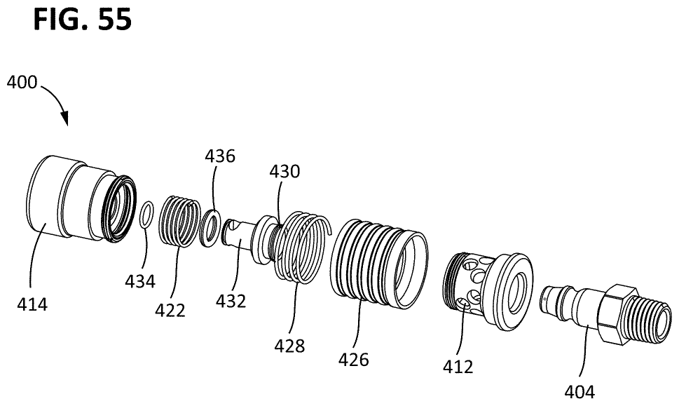

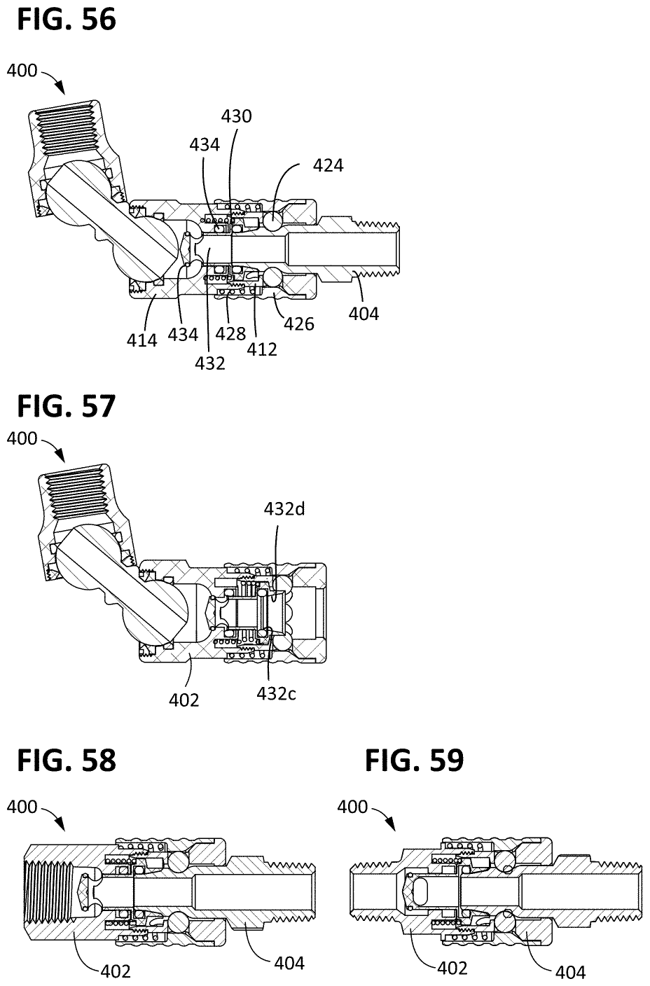

Referring to FIGS. 53 to 59, a variation of the coupling assembly 100 is presented in which a coupling assembly 400 having a first part 402 and a second part 404 is shown. In contrast to coupling assembly 100, the second part 404 of coupling assembly 400 is provided without an internal seal member for sealing the second part 404 to the piston 432. Instead, the second part 404 is provided with a tapered or narrowed nose which forms a seal with a seal member 430 that is housed internally within the piston 432. With such a configuration, the surface 404f on the second part 404 engages with a complementarily shaped surface 432d on the piston 432, wherein each of the surfaces 404f, 432d are oriented at an oblique angle to the longitudinal axis of the coupling arrangement 400. Contact is also made between the end 404b of the second part 404 and an end surface 432c of the piston 432 which is guided into alignment by the surfaces 404f, 432d. The surface area engagement between the surfaces 404f and 432d and the surfaces 404b, 432c enables for significantly enhanced engagement between the piston 432 and second part 404 and eliminates a common prior art requirement that a plug and piston 432 be perfectly aligned for end-to-end contact without any further guiding features. This arrangement also allows for the internal diameter of the second part 404 and piston 432 to be significantly larger than prior art designs while simultaneously achieving low insertion pressures, as previously described. The coupling arrangement 400 is also shown with the first part 402 being provided without the ring 120 and the second part 404 being provided without a radial flange such that the safety feature of preventing uncontrolled ejection of the second part 404 during the decoupling process is removed in this example.

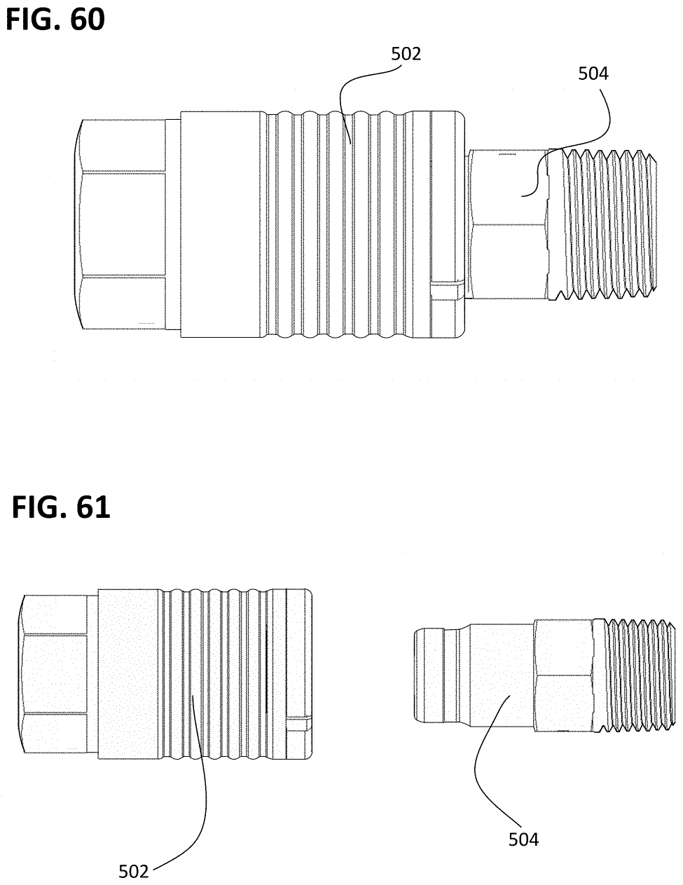

### Coupling Arrangement 500—FIGS. 60-100

Referring to FIGS. 60 to 63, a coupling arrangement 500, is presented. The coupling arrangement 500 has features in common with the previously described coupling arrangements and like reference numbers will therefore be used with reference to coupling arrangement 500. Where features are the generally the same, their description will not necessarily be repeated as more emphasis is placed on the differences. One difference associated with coupling arrangement 500 is that the ball bearings 524 of the coupling arrangement 500 do not come into direct contact with the second part 504 when engaged with the first part 502. This arrangement can have the effect of reducing friction between the first and second parts 502, 504, thus enabling the second part 504 to more freely rotate with respect to the first part 502. Another difference associated with coupling arrangement 500 is that the temporary locking action of the second part 504 to the first part 502 after initial disconnection but before the internal pressure of the internal gas has sufficiently vented, is reinforced by the internal pressure rather than working against the internal pressure. Stated another way, after initial disconnection, the internal pressure within the coupling 500 reinforces the temporary locking action between the first and second parts 502, 504 until the pressure has sufficiently vented or otherwise dissipated. These differences are discussed further below.

Although coupling arrangement 500 can be configured for other types of fluids (e.g. liquids), coupling arrangement 500 is shown as being configured for use with a gas, such as compressed air. As shown, the coupling arrangement 500 is configured as a quick-connect coupler with a first part 502 and a second part 504 received by the first part 502. In one aspect, the first part 502 can be characterized as a female part of the coupling arrangement 500 and the second part 504 can be characterized as a male part of the coupling arrangement 500. The coupling arrangement 500 is configured such that the second part 504 will not disconnect from the first part 502 until a sufficient amount of pressure within the coupling arrangement 500 has been bled out of the coupling arrangement 500. This feature increases safety in ensuring that the second part 504 is not ejected rapidly out of the first part 502 in a way that increases risk of harm to an operator. The coupling arrangement 500 is also configured such that the insertion force required to insert the second part 504 into the first part 502 is relatively low, in comparison to prior art coupling arrangements. This feature is particularly advantageous when the coupling arrangement 500 is utilized in a high pressure environment (e.g. line pressures around 200 psi) where an operator is generally required to apply a significant amount of force to insert a plug into a coupler.

In one aspect, the first part 502 is an assembly including a main body 510 formed by a first body part 512 to which a second body part 514 is connected. In the example shown, the first body part 512 and the second body part 514 have sidewalls 512a, 514a with an axis of symmetry about a longitudinal axis X of the first part 502 and are interconnected by a threaded connection. To facilitate this connection, the first body part 512 is provided with internal threads 512b while the second body part 514 is provided with mating external threads 514b. The reverse arrangement is also possible with the first body part 512 including external threads and the second body part 514 including internal threads. Other connection types are also possible. Also, although more complex to produce, the first part 502 could be unitarily formed as a single body having the features of the first and second body parts 512, 514.

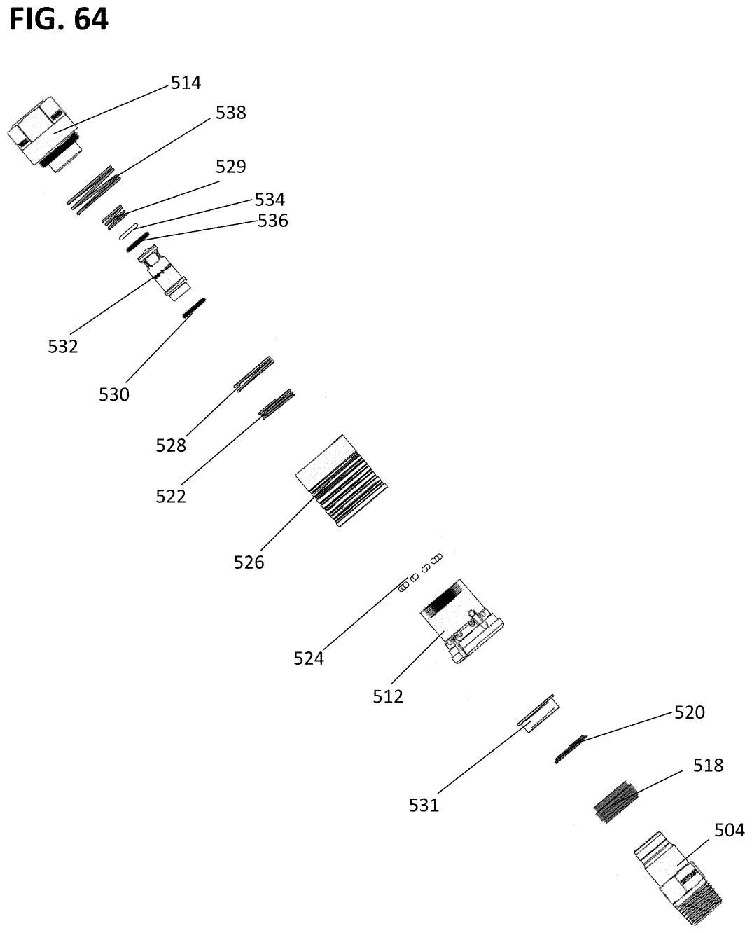

With reference to FIG. 64, an exploded view of the coupling arrangement 500 is presented such that the individual components of the coupling arrangement 500 can be more easily viewed. In order, from the second part 504 towards the second body part 514, the coupling arrangement 500 is shown as including, a carrier ring 518, a lock ring 520, a lock member 521, the first body part 512, a plurality of ball bearings 524, a sleeve member 526, a spring member 529, a spring member 538, a first seal member 530, a piston 532, a seal member 536, a seal member 534, a spring member 522, a spring member 528, and the second body part 514. As shown, the spring members 522, 528, 529, 538 are helical or coiled springs that can be formed from a metal material, such as spring steel. The seal members 530, 534, and 536 are shown as being configured as O-rings and can be formed from a polymeric material, such as a rubber material. The remaining aforementioned components and their functions will be described in the following paragraphs. In one aspect, the lock ring 520, the carrier 518, and the lock member 521 can be characterized as being a safety catch arrangement that prevents ejection of the second part after initial decoupling until fluid pressure within the coupling assembly 500 drops below a threshold.

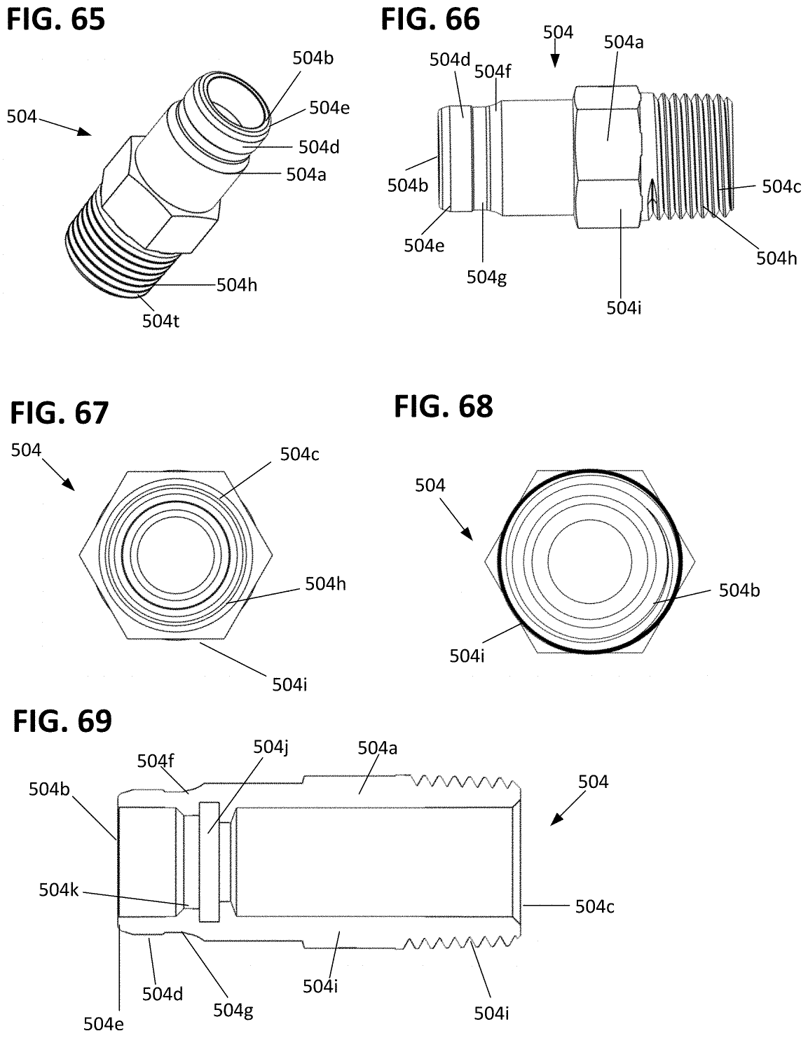

With reference to FIGS. 65 to 69, the second part 504 is shown in isolation such that the details of the second part 504 can be more easily viewed. As shown, the second part 504 includes a sidewall 504a having an axis of symmetry about the longitudinal axis X. The sidewall 504a extends between a first end 504b and a second end 504c. The first end 504b includes an interface for interconnecting with the lock ring 520 of the first part 502, with the interface defining an outer collar surface 504d defining a radial flange or shoulder 504e against which the lock ring 520 abuts. The interface can also be described as including a ramped surface 504f and a recess 504g, wherein the ramped surface 504f provides a stop surface for the carrier 518 when the first and second parts 502, 504 are engaged. In one aspect, the ramped surface 504f has a circular concave shape matching a correspondingly shaped surface of the carrier 518. In one aspect, this complementary shape between the recess ramped surface 504f and the carrier 518 creates a smooth interacting surface that provides a low-friction interface between the second part 504 and the first part 502 which in turns enables the first and second parts 502, 504 to easily rotate with respect to each other. This configuration allows for an operator to much more easily handle and articulate a tool connected to the coupling arrangement 500 during use.

In one aspect, the second end 504c is shown as including an interface for interconnecting with an air hose or tool. In the example shown a threaded connection 504h with external threads, such as a Tru-Flate 21-143 1/4 NPT male fitting. However, other types of arrangements may be used, such as female threads or a barbed fitting for connecting with an air hose, such as a 3/8 ID hose barb type fitting manufactured by Plews and Edelman of Dixon, Illinois. The sidewall 504a can be provided with a hex-shaped tool interface 504i such that a tool can be used to rotate (or hold in a fixed position) the second part 504 to connect the second part 504 to a tool or other component via threads 504h. The internal side of the sidewall 504a is also shown as defining a seal cavity or channel 504j for receiving and retaining the seal member 530. The seal member 530 operates to ensure an air-tight seal between the second part 504 and an outer surface of the piston 532, when the second part 504 is inserted into the first part 502. The second part 504 is also shown as including an interior surface 504k for engaging with the piston 532.

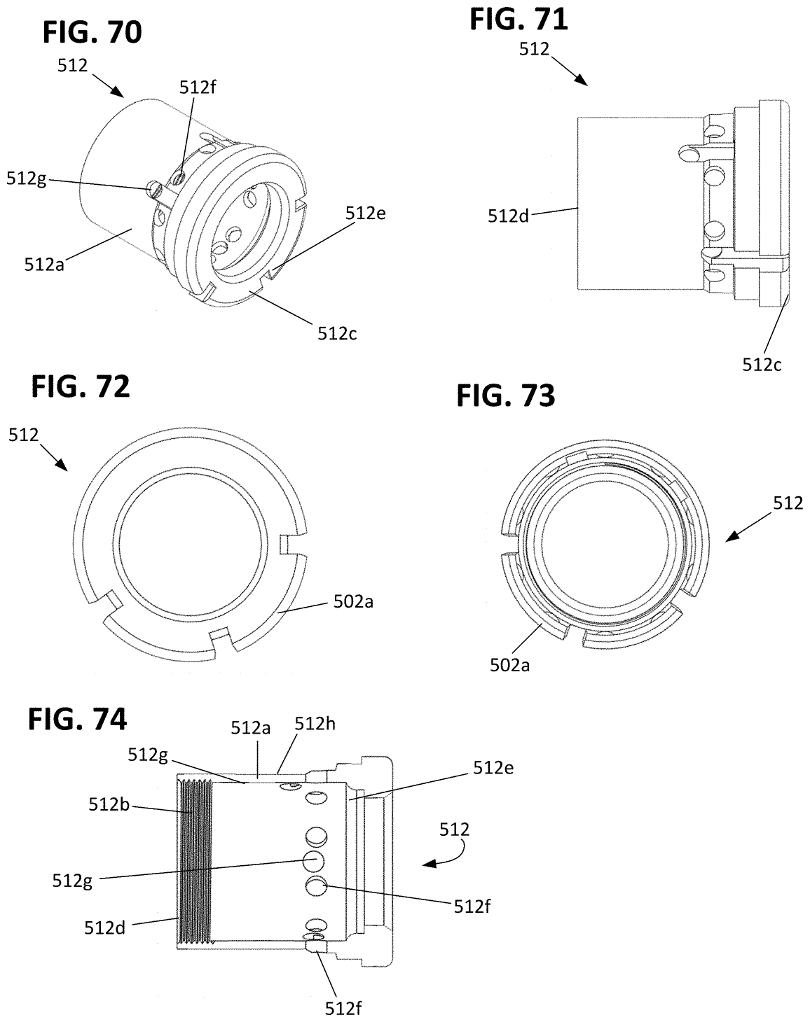

With reference to FIGS. 70-74, the first body part 512 is shown in isolation such that the details of the first body part 512 can be more easily viewed. As shown, the first body part sidewall 512a extends between a first end 512c and a second end 512d with the first end 512c defining an internal shoulder 512e and the second end 512d defining the aforementioned threaded connection 512b. In one aspect, the internal shoulder 512e acts as a stop against a bearing surface 518f of the carrier 518 when the second part 504 is not inserted into the first part 502. In this position, an outer surface 518e of the carrier 518 prevents the ball bearings 524 from passing fully inwardly through apertures 512f of the first body part 512, which axially retain the ball bearings 524 in position. On the other side of the ball bearings 524, the sleeve part 526 acts against an outer surface of the ball bearings 524 to hold the bearings 524 within the apertures 512f of the first body part 512. When the sleeve part 526 is moved axially away from the second part 504, the ball bearings 524 can move radially outwardly within the apertures 512f towards a second position such that the ball bearings 524 can slide radially outward and beyond the carrier 518, with an axial pulling force applied to the second part 504 in the direction towards the second end 504c. In the example shown, ten apertures 512f and ball bearings 524 are shown as being provided. However, more or fewer apertures 512f and ball bearings 524 could be provided. In the example shown, the ball bearings have a diameter of about one eighth of an inch and are formed from a polymeric material. In some examples, the ball bearings are formed from an acetal thermoplastic (i.e. PolyOxyMethylene or POM) such as copolymer acetal or homopolymer acetal. In some examples, the ball bearings are formed from DELRIN manufactured by DuPont. Other materials are possible, such as metal, although at a higher cost and with reduced functionality in some cases.

In one aspect, the sidewall 512a includes another set of apertures 512g. The apertures 512g are for venting air during disconnection of the second part 504 from the first part 502. The incorporation of the apertures 512g into the sidewall 512a enables for a venting pathway V to be created from the interior side of the sidewall 512a, through the sidewall 512a, and through the interstitial space defined between the exterior of the sidewall 512a and the sleeve member 526. Thus, when the second part 504 is disconnected from the first part 502, the volume of compressed air within the coupling arrangement 500 is directed through the venting pathway V instead of escaping around the second part 504 where it would otherwise be directed towards the operator performing the disconnecting action. As the venting pathway V exit (i.e. pathway defined between sleeve member 526 and sidewall 512a) is directed oppositely from the removal direction of the second part 504, the vented air does not exert an additional force onto the second part 504 during the disconnection action. Thus, the disclosed configuration significantly reduces the ejection pressure exerted on the second part 504 during disconnection. In some prior art arrangements, where the air is vented in the same direction as the removal direction of the plug, the ejection pressure is high enough to cause rapid ejection of the plug to dangerously become a projectile.

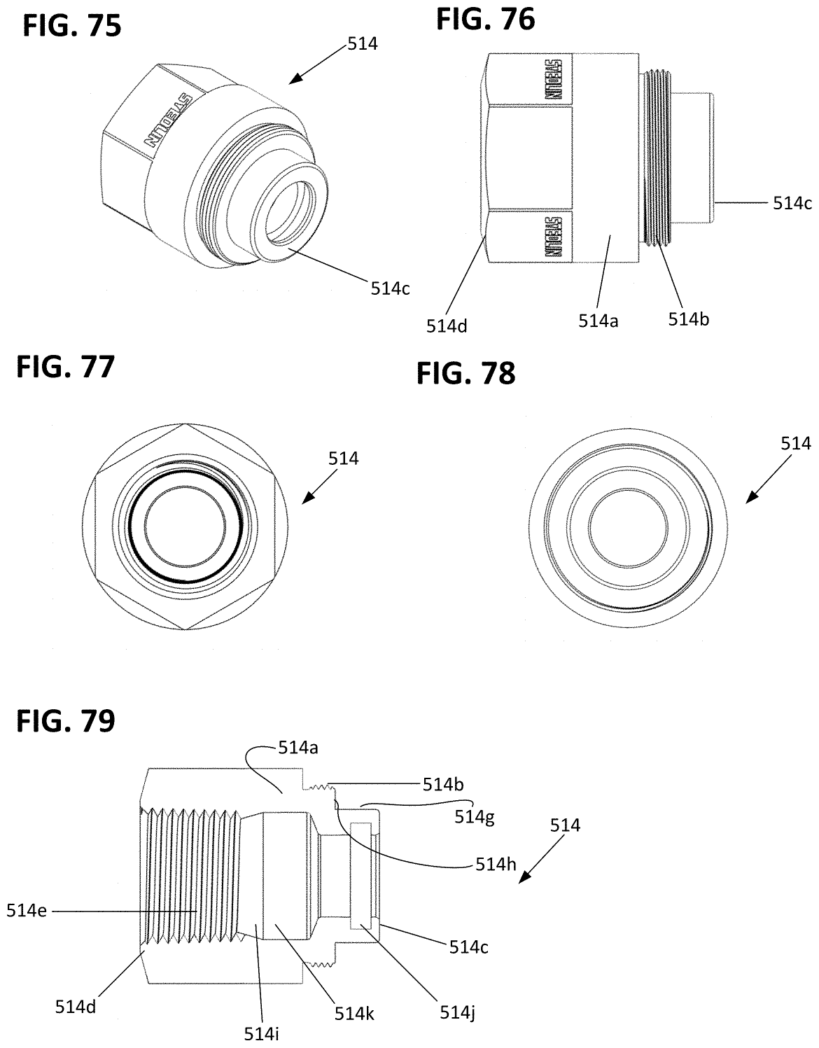

With reference to FIGS. 75 to 78, the second body part 514 is shown in isolation such that the details of the second body part 514 can be more easily viewed. As shown, the second body part sidewall 514a extends between a first end 514c and a second end 514d with the threaded connection 514b that interfaces with threaded connection 512c being proximate the first end 514c. The second end 514d is configured with a threaded connection 514e. The second end 514d can be provided with other types of arrangements for alternative connection types. For example, the second end 514d could be provided with external threads or a barbed fitting for connecting with an air hose. The second body part sidewall 514a is also shown as being provided with an internal seal cavity or channel 514f for retaining seal member 536 such that an air-tight seal can be formed between the second body part 514 and the piston 532. The second body part sidewall 514a is also shown as being provided with an outer collar surface 514g and an adjacent stop surface 514h about and against which spring 528 is disposed, which allows the spring 528 to act against the sleeve part 526 such that the sleeve part 526 is biased towards the closed position where the ball bearings 524 are retained in their innermost position when the second part 504 is connected from the first part 502. The second body part 514 further includes a stop surface 514j against which spring 529 acts to bias the lock member 521 in a locked position whereby the lock member 521 surrounds the lock ring 520 to prevent the lock ring 520 from expanding and passing over the radial flange or shoulder 504e of the second part 504. Also, the end surface 514c of the second body part 514 provides a stop surface for the spring 522 which biases the piston 532 into the closed position. The second body part 514 is also shown as being provided with an internal groove or recess 514f for accepting the seal member 536 which provides a seal between the second body part 514 and the piston 532. It is noted that the second body part 514 could be configured with an orbital connection of the type shown for coupling arrangement 100 instead of the depicted threaded connection.

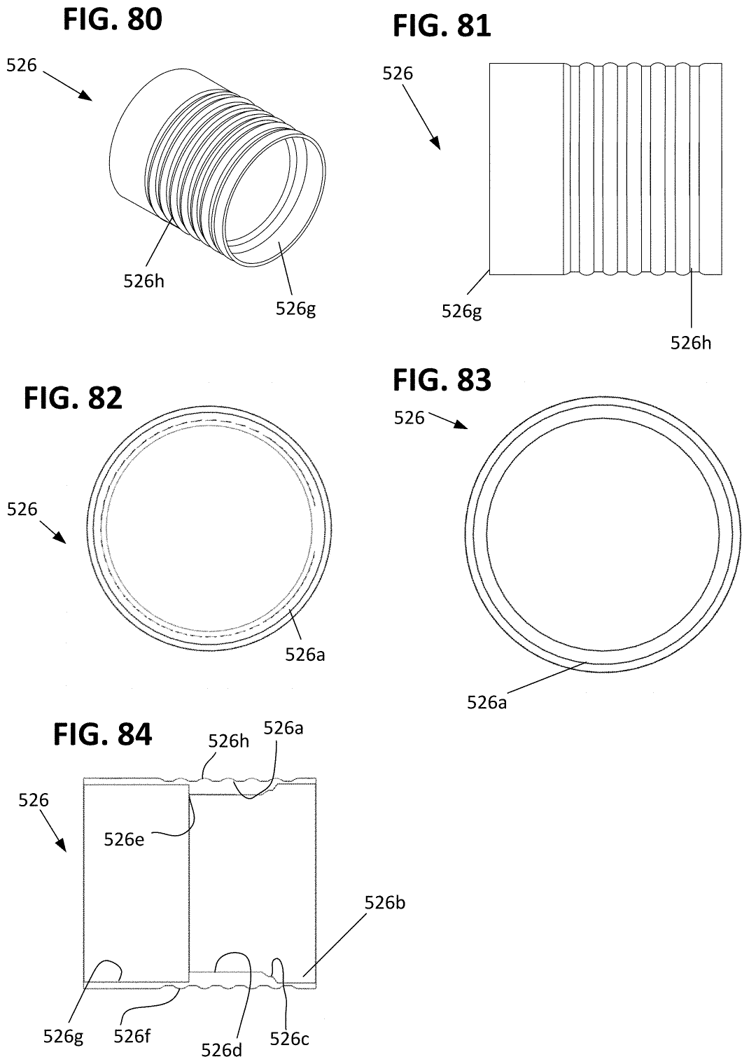

With reference to FIGS. 80 to 84, the sleeve member 526 is shown in isolation such that the details of the sleeve member 526 can be more easily viewed. As shown, the sleeve member 526 includes a sidewall 526a defining inner surfaces 526b, 526c, 526d, 526e, and 526f. The sidewall 526a also defines an outer surface 526g with circumferential ridges 526h to enable an operator to slide the sleeve member 526 with respect to the first body part 512. In one aspect, the ball bearings 524 rest against the inner surface 526b when the sleeve is retracted into an open position such that the ball bearings 524 can move radially outwardly and release the carrier 518. As the sleeve 526 is moved towards the closed positon by the force of the spring 538 acting against surface 526e, a ramped inner surface 526c forces the ball bearings 524 further into the apertures 512f of the first body part 512. As the sleeve 526 moves fully into the closed positon by the force of spring 528, the ball bearings 524 are secured against the inner surface 526d and are fully engaged with the surface 518f of the carrier 518. In one aspect, the spring 528 resides in the interstitial space between the inner surface 526f of the sleeve member 526 and the outer surface of the first body part 512.

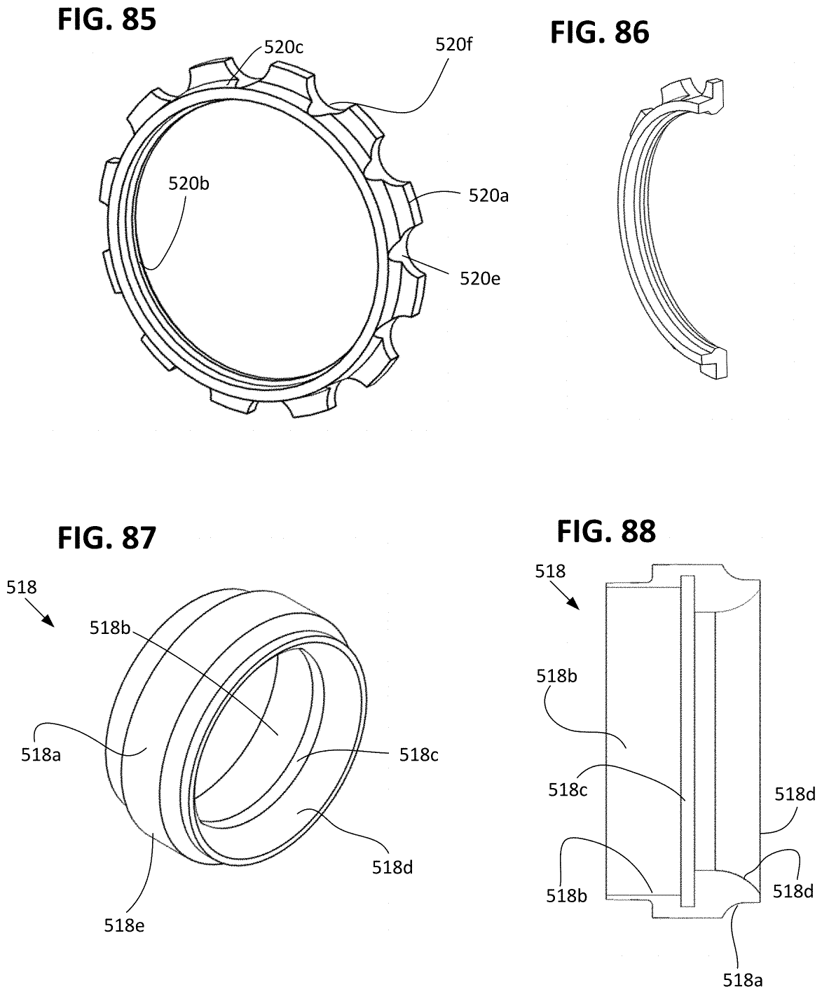

With reference to FIGS. 85 to 86, the lock ring 520 is shown in isolation such that the details of the lock ring 520 can be more easily viewed. In one aspect, the ring 520 includes a sidewall 520a with an inner surface 520b and outer surfaces 520c and 520d. The ring 520 is shown as being configured as a split ring having a gap 520e.

With reference to FIGS. 87 to 88, the carrier 518 is shown in isolation such that the details of the carrier 518 can be more easily viewed. In one aspect, the carrier 518 includes a sidewall 518a with inner surfaces 518b, 518d, a recess 518c, and an outer surface 518e. In one aspect the carrier 518 includes a plurality of half-circle shaped openings 518f located on the outer surface 518a. The lock ring 520 can be installed within the carrier recess 518c by compressing the lock ring 520 such that the gap 520e closes and then allowing the ring 520 to spring back into its resting state once within the recess 518c. Once installed, the carrier 518 and lock ring 520 reside within the first body part 512 and are axially displaceable within the first body part 512, as is described further below.

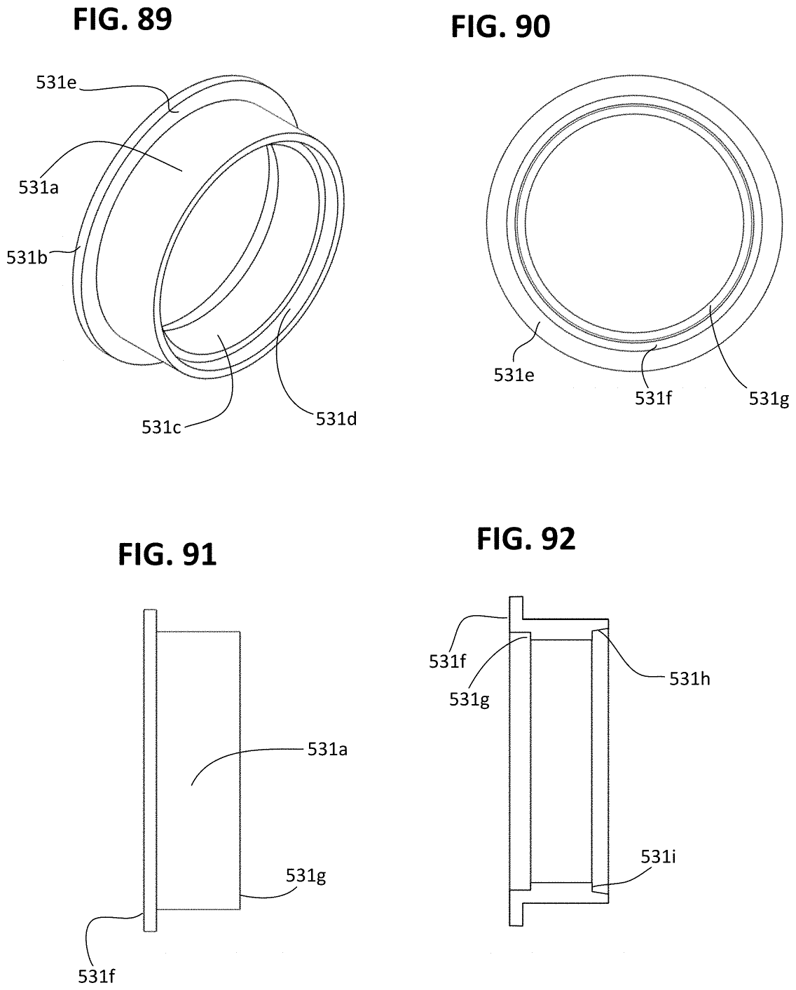

With reference to FIGS. 89 to 92, the lock member 521 is shown 532 is shown in isolation such that the details of the lock member 521 can be more easily viewed. The lock member 521 is shown as including an outer wall 521a, a radial flange 521b, an inner surface 521c, an inner surface 521d, a stop surface 521e, an end surface 521f, and a stop surface 521g. The lock member is installed within the first body part 512 such that when in a first or locked position, the inner surface 521d surrounds the outer surface 520c of the lock ring 520, thereby preventing the lock ring 520 from expanding within the recess 518c of the carrier 518. Accordingly, in this position, the lock ring 520 is prevented from expanding over the radial flange or shoulder 504e of the second part 504 and the second part 504 is therefore locked onto the first part 502, even with the sleeve part 526 retracted into the open position. The stop surface 521e of the lock member 521 provides a surface against which spring 538 acts. Accordingly, the spring 538 exerts and force against the lock member 521 to bias the lock member 521 towards an unlocked position wherein the inner surface 521d no longer overlaps the outer surface 520c of the lock ring 520. As the second part 504 is removed from the first part 502, the spring 538 extends to the end of its travel length, thereby allowing the spring 538 to decouple the lock member 521 from the lock ring 520 once internal pressure decreases sufficiently through venting via the venting passageway V in the manner described below. With such an arrangement, the second part 504 is prevented from immediately ejecting from the first part 502 when the parts are initially decoupled by retracting the sleeve part 526 into the unlocked position, wherein the second part 504 is only released by the movement of the lock member 521 until a safe, low internal pressure within the coupling 500 exists.

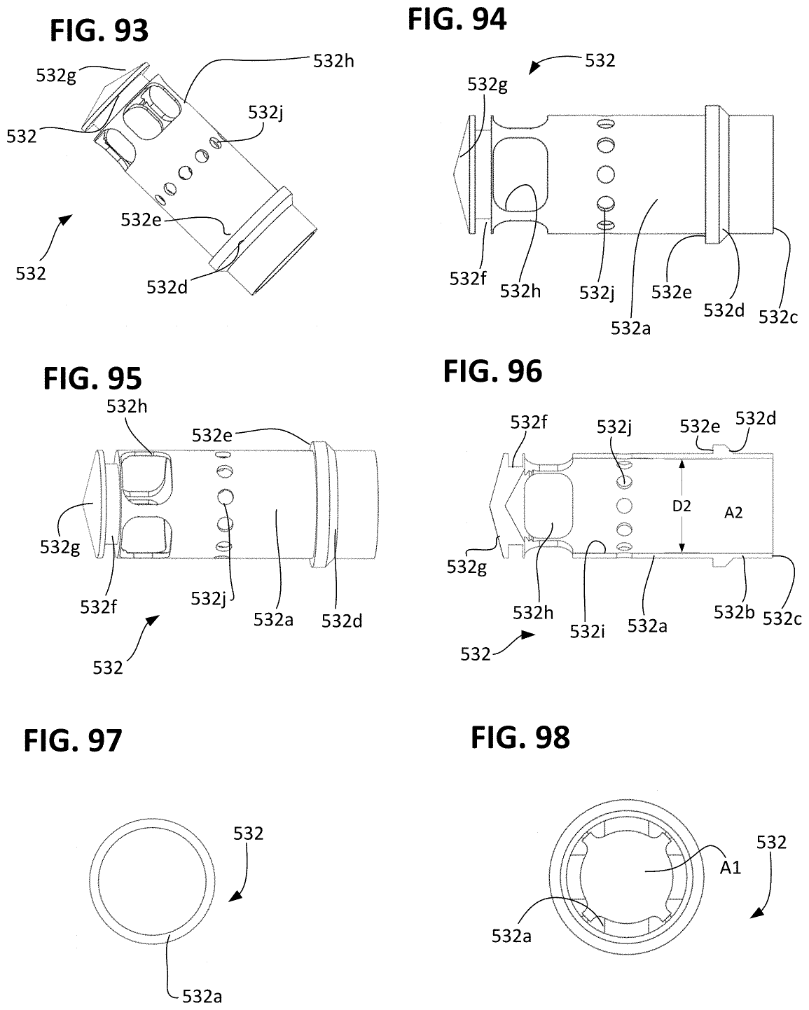

With reference to FIGS. 93 to 98, the piston 532 is shown in isolation such that the details of the piston 532 can be more easily viewed. The features of the piston 532 are generally the same as the features of the piston 132 and need not be further described herein. Where like features exist the features are similarly numbered, but using a 500 series number instead of a 100 series number. Accordingly, the previous description for such like numbers for the piston 132 is applicable for the piston 532 shown at FIGS. 93 to 98. The piston 532 is shown with additional ports 532j that are not present on the piston 132. The ports 532j allow for additional passageways for venting of compressed air.

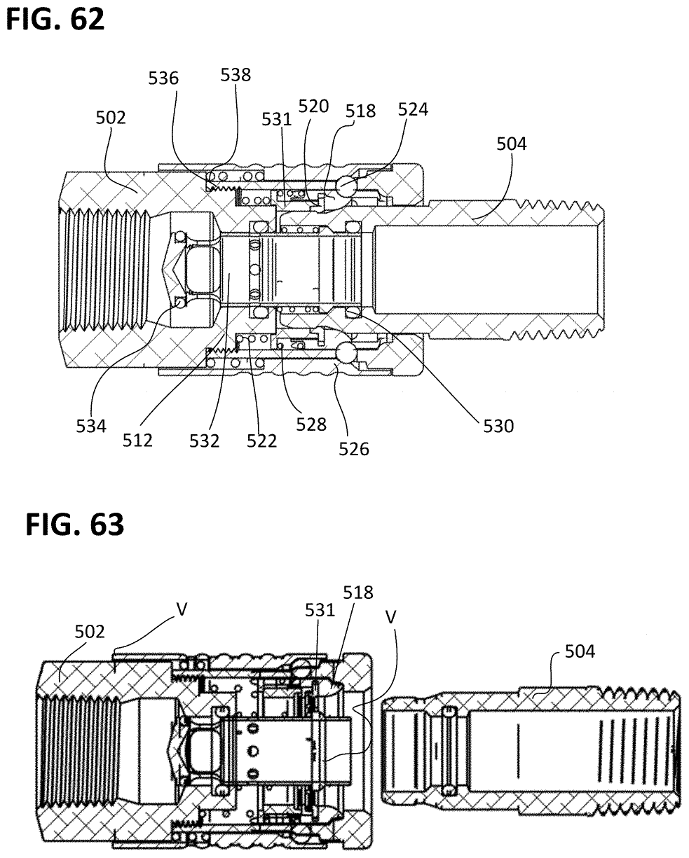

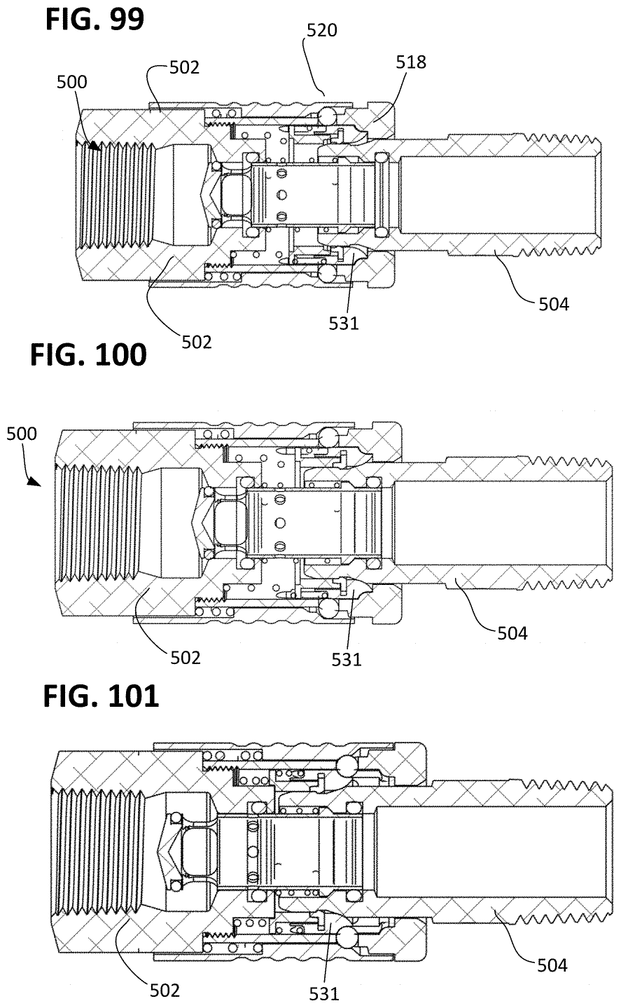

With reference to FIGS. 99 to 100, the coupling and decoupling operations of the coupling arrangement 500 are shown at various stages of interconnection between the uncoupled state shown at FIG. 63 and the coupled state shown at FIG. 62.

FIG. 99 shows the coupling arrangement 500 in a partially inserted or removed state. When the second part 504 is initially inserted into the first part 502, the tapered nose portion of the collar 504d, at the second end 504b, engages into the opening defined by the lock ring 520. In the relaxed state, the internal diameter of the lock ring 520 is slightly less than the outer diameter of the first part 502 at the collar 504d. As such, the lock ring 520 initially expands around the collar 504d, as shown at FIG. 99. At this point, the spring 529 provides sufficient force to hold the lock ring 520 from being displaced in the same direction as the second part 504 thereby forcing the lock ring 520 to expand over the collar 504d during insertion. As the second part 504 is displaced further into the first part 502, the spring 538 lock ring 520 eventually slides past the collar 504d and snaps into the recess 504g of the second part 504 such that the lock ring 520 engages against the radial flange or shoulder 504e, as shown at FIG. 100. At the position where this action initially occurs, the piston 532 has not yet been displaced into an open position which would otherwise allow for compressed air or gas to fill the internals of the coupling. Accordingly, the lock member 521 is held in the open or unlocked position away from the lock ring 518 by the force of the spring 538. In this position, the second part 504 can be easily removed from the first part 502 by overcoming the relatively low resistance of the lock ring 520 as it expands back around the collar 504d. Notably, the inner surface 520b of the lock ring 520 that engages with the radial flange or shoulder 504e and the radial flange or shoulder 504e itself have complementary beveled surfaces which are oblique to the longitudinal axis X. This configuration creates a ramped engagement between the components such that an ejection or pulling force on the second part 504 translates to an expanding force on the lock ring 520. Accordingly, when the coupling assembly 500 is initially decoupled by retracting the sleeve member 526, the compressed air forces the second part 504 away from the first part 502 in the disengaged direction which in turn creates the expanding force on the lock ring 520. As the lock member 521 is sleeved over the lock ring 520 at this point, the air pressure and resulting expanding force causes the lock ring 518 to expand against and frictionally engage the lock member 520 such that the lock member is prevented from sliding off of the lock ring 518. This action therefore secures the second part 504 to the first part 502 until the internal pressure has subsided to the point where little or no ejection force is created on the second part 504. At this point, the spring 538 can move the lock member 521 away from the lock ring 518 and the second part 504 can be disengaged from the first part 502 by pulling the second part 504 and expanding the lock ring 518 over the collar 504d. The ramped surfaces between the lock ring 518 and the second part 504 allow the second part 504 to be more easily disengaged from the second part 518 when the lock member 521 is in the unlocked position.

As the second part 504 is further inserted into the first part 502, the spring 529 will start to engage against the lock member 521 such that the lock member 521 is moved into a locked position whereby the inner surface 521c of the lock member slides over the outer surface 520c of the lock ring to prevent the lock ring 520 from expanding over the radial flange or shoulder 504e of the second part 504. Also during insertion, the surface 504f of the second part 504 engages with the surface 518d of the carrier 518 to drive the carrier 518 in the insertion direction until the carrier 518 is displaced far enough for the surface 518f to receive the ball bearings 524. Once this position has been obtained, the sleeve 526 can slide over the ball bearings 524 to fully lock the second part 504 within the first part 502. Also during insertion, the second part surface 504k engages with the piston 532 to move the piston 532 from the closed position to the open position. This fully coupled state is shown at FIG. 63.

Referring back to FIG. 100, this position can be referred to as a safe vent state wherein the lock member 521 remains engaged with the lock ring 518 to prevent decoupling of the second part 504 from the first part 502 even though the ball bearings 524 are no longer retaining the second part 504 to the first part 502. As previously described, the sleeve 526 can be retracted into an unlocked or open position to allow the ball bearings 524 to move radially outwards to disengaged the ball bearings 524 from the carrier 518. Once this occurs, the second part 504 initially moves in the decoupling direction with the spring 529 holding the lock member 521 against the lock ring 518. Eventually, the spring 529 runs out of travel and the surface 518f of the carrier 520 abuts the internal shoulder 512e of the first body part 512 with the piston 532 moving to the closed position, as shown at FIG. 100. Although the spring 529 is no longer holding the lock member 521 in the locked position against the lock ring 518 in this position, the internal pressure in the coupling assembly 500 will act against the second part 504 to drive the lock ring 518 against the lock member 521, as described, until sufficiently vented through the venting pathway V. As described previously, once this pressure subsides, the spring 538 can then operate to disengage the lock member 521 from the lock ring 518 and the second part 504 can then be removed from the first part 502.

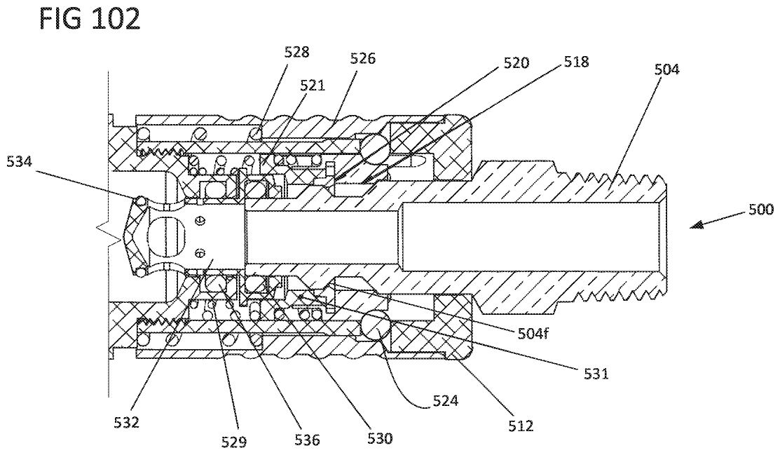

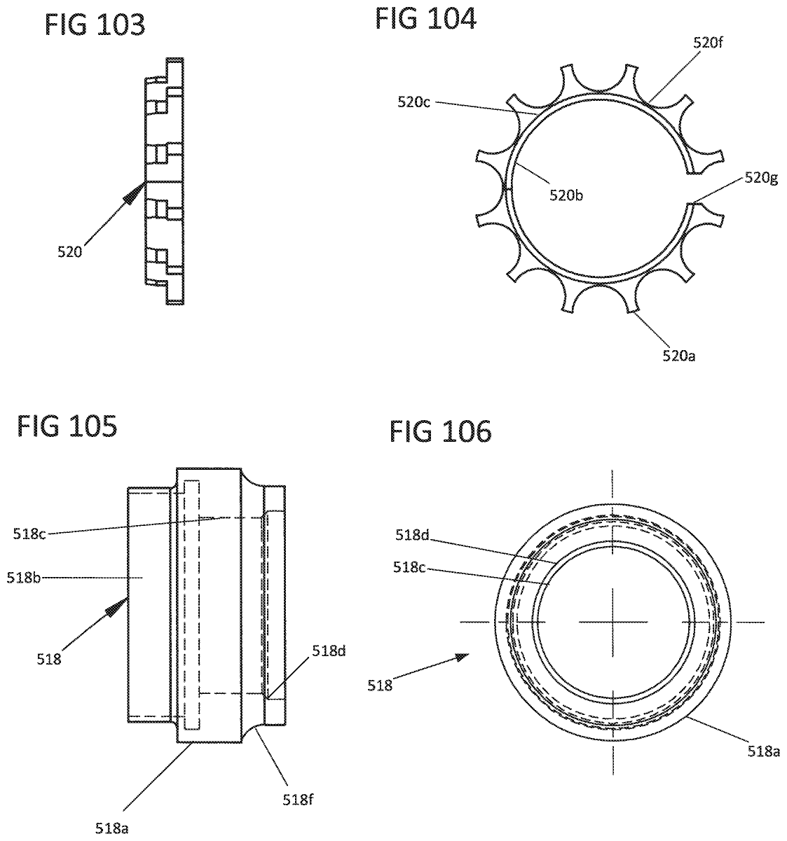

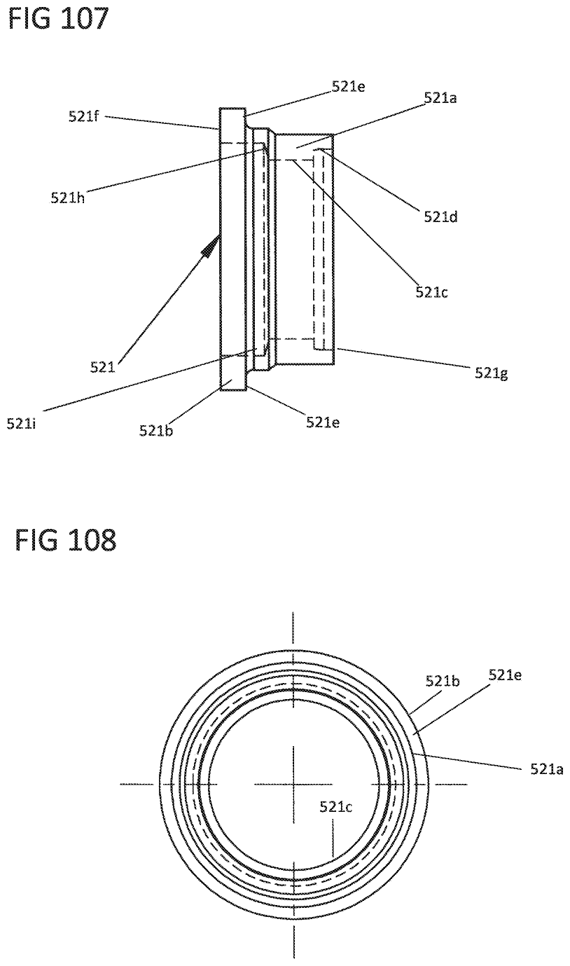

### Coupling Arrangement 500—FIGS. 101 to 108

Referring to FIGS. 101 to 108, a variation of the coupling assembly 500 is presented in which a coupling assembly 500 having a first part 502 and a second part 504 is shown. In contrast to coupling assembly 500, the second part 504 of coupling assembly 500 is provided without an internal seal member for sealing the second part 504 to the piston 532 and the second part 504 is configured as an industry standard plug (e.g. an M or D style plug). With such a configuration, the second part 504 is provided with a narrowed nose portion which forms a seal with a seal member 530 that is housed internally within the piston 532 in an arrangement generally similar to that already shown and described for coupling assembly 400. A radial flange or shoulder surface 504e on the second part 504 engages with the inner surface of the lock ring 518 which is received into a carrier 520 and interacts with a lock member 521 in the same general manner as previously described.

The features shown and described for the various coupling assemblies 100, 200, 300, 400, and 500 are not exclusive to each embodiment. Rather, the features of any of the coupling assemblies 100, 200, 300, 400, 500 may be integrated into any of the other coupling assemblies 100, 200, 300, 400, 500. For example, the male and female type connections shown at FIGS. 58 and 59 for the coupling assembly 400 may be provided for the coupling assemblies 100, 200, 300 instead of the shown orbital coupling arrangement.

In some examples, all of the components of the coupling arrangements 100, 200, 300, 400, and 500 can be formed from a polymeric material, such as polyurethane. For example, the components can be formed by injection molding. In one example, the second parts are formed from a high impact polyurethane by reaction injection molding. In some examples, the springs are formed from a steel material, the seals are formed from a polymeric rubber material, and the remaining components are formed from a polymeric material (e.g. acetal, polyurethane, etc.).

From the forgoing detailed description, it will be evident that modifications and variations can be made in the aspects of the disclosure without departing from the spirit or scope of the aspects. While the best modes for carrying out the many aspects of the present teachings have been described in detail, those familiar with the art to which these teachings relate will recognize various alternative aspects for practicing the present teachings that are within the scope of the appended claims.

What is claimed is:

1. A coupling arrangement comprising:
a) a first part defining a first internal passageway and including a safety catch arrangement;
b) a piston disposed within the internal passageway, the piston being movable between an open position in which airflow can pass through the internal passageway and a closed position in which airflow through the internal passageway is blocked;
c) a second part defining a second internal passageway, the second part being configured to be selectively coupled and uncoupled with the first part such that the first and second internal passageways are in fluid communication with each other, wherein when the second part is coupled to the first part, the piston is in the open position and when the second part is uncoupled from the first part, the piston is in the closed position;
d) wherein the second part includes a radial flange for momentarily engaging with the safety catch arrangement when the second part is decoupled from the first part and a fluid pressure within the first internal passageway exceeds a threshold.

2. The coupling arrangement of claim 1, wherein the safety catch arrangement includes a lock member and a lock ring receivable by the lock member.

3. The coupling arrangement of claim 2, wherein the lock ring is a split ring movable between first and second diameters.

4. The coupling arrangement of claim 3, wherein the lock ring engages with the radial flange of the second part.

5. The coupling arrangement of claim 4, wherein the lock ring has a first surface that abuts a second surface of the radial flange and wherein the first and second surfaces are disposed at an oblique angle to a longitudinal axis of the coupling arrangement.

6. The coupling arrangement of claim 1, wherein the internal seal is an O-ring.

7. The coupling arrangement of claim 1, wherein the second part is formed from an aluminum material.

8. The coupling arrangement of claim 1, wherein the lock member is movable between a locked position and an unlocked position such that when in the locked position, the lock ring is prevented from expanding to the second diameter such that the second part is locked in position by the lock ring, and such that when in the unlocked position, the lock ring is enabled to expand to the second diameter such that the second part is removable from the first part.

9. The coupling arrangement of claim 2, wherein the safety catch arrangement further includes a carrier with an internal recess receiving the lock ring, wherein the carrier has an external surface for receiving ball bearings of the first part such that the second part is free of direct contact from the ball bearings when the second part is coupled to the first part.

10. A coupling arrangement comprising:
a) a first part defining a first internal passageway;
b) a piston disposed within the internal passageway, the piston being movable between an open position in which airflow can pass through the internal passageway and a closed position in which airflow through the internal passageway is blocked;
c) a second part defining a second internal passageway, the second part being configured to be selectively coupled and uncoupled with the first part such that the first and second internal passageways are in fluid communication with each other, wherein when the second part is coupled to the first part, the piston is in the open position and when the second part is uncoupled from the first part, the piston is in the closed position; and
d) an internal seal housed within the second part, wherein the internal seal forms a seal between the second part and an outer surface of the piston when the second part is coupled to the first part.

11. The coupling arrangement of claim 10, wherein the internal seal is an O-ring.

12. The coupling arrangement of claim 10, wherein the second part is formed from an aluminum material.

13. The coupling arrangement of claim 10, wherein the second part includes a radial flange for momentarily engaging with a safety catch arrangement of the first part when the second part is decoupled from the first part and a fluid pressure within the first internal passageway exceeds a predetermined threshold.

14. The coupling arrangement of claim 10, wherein the second part defines an external groove for accepting ball bearings of the first part, wherein the external groove has a semi-circular shape.

15. The coupling arrangement of claim 10, wherein the first part defines a vent passageway extending from the internal passageway, through a sidewall of a main body part of the first part, and through an interstitial space defined between the sidewall and a sleeve member of the first part.

16. A coupling arrangement comprising:
a) a first part defining a first internal passageway;
b) a piston disposed within the internal passageway, the piston being movable between an open position in which airflow can pass through the internal passageway and a closed position in which airflow through the internal passageway is blocked;
c) a second part defining a second internal passageway, the second part being configured to be selectively coupled and uncoupled with the first part such that the first and second internal passageways are in fluid communication with each other, wherein when the second part is coupled to the first part, the piston is in the open position and when the second part is uncoupled from the first part, the piston is in the closed position; and
d) wherein the first part defines a vent passageway extending from the internal passageway, through a sidewall of a main body part of the first part, and through an interstitial space defined between the sidewall and a sleeve member of the first part.

17. The coupling arrangement of claim 16, further including an internal seal housed within the second part, wherein the internal seal forms a seal between the second part and an outer surface of the piston when the second part is coupled to the first part.

18. The coupling arrangement of claim 17, wherein the internal seal is an O-ring.

19. The coupling arrangement of claim 16, wherein the second part is formed from an aluminum material.

20. The coupling arrangement of claim 16, wherein the second part includes a radial flange for momentarily engaging with a safety catch arrangement of the first part when the second part is decoupled from the first part and a fluid pressure within the first internal passageway exceeds a threshold.
